(19) United States
(12) Patent Application Publication
(10) Pub. No.: US 2023/0246219 A1
(43) Pub. Date: Aug. 3, 2023

(54) ELECTROLYTE MANAGEMENT FOR A REBALANCING CELL

(71) Applicant: ESS TECH, INC., Wilsonville, OR (US)

(72) Inventors: Sean Kissick, Portland, OR (US); Yang Song, West Linn, OR (US)

(21) Appl. No.: 18/163,832

(22) Filed: Feb. 2, 2023

Related U.S. Application Data
(60) Provisional application No. 63/267,522, filed on Feb. 3, 2022.

(51) Int. Cl. H01M 8/18; H01M 8/04186; H01M 8/04082; H01M 8/04276; H01M 16/00; H01M 8/0656

(52) U.S. Cl. CPC H01M 8/188; H01M 8/04186; H01M 8/04201; H01M 8/04276; H01M 16/006; H01M 8/0656

(57) ABSTRACT

Systems and methods are provided for a redox flow battery system. In one example, the redox flow battery system includes one or more redox flow battery cells, a rebalancing cell receiving electrolyte from the one or more redox flow battery cells and catalyzing hydrogen reduction of metal cations in the electrolyte, and a conductive coupler connecting the rebalancing cell to an external voltage source. The conductive coupler enables application of an ion-repelling potential to a stack of electrode assemblies of the rebalancing cell during operation of the redox flow battery system.

### CROSS-REFERENCE TO RELATED APPLICATIONS

The present application claims priority to U.S. Provisional Application No. 63/267,522, entitled “ELECTRODE MANAGEMENT FOR A REBALANCING CELL,” and filed on Feb. 3, 2022. The entirety of the above-listed application is hereby incorporated by reference for all purposes.

### FIELD

The present description relates generally to systems and methods for storing electrolytes for use in a redox flow battery system and for flowing and rebalancing the electrolytes during operation of the redox flow battery system.

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. An all-iron hybrid redox flow battery is particularly attractive due to incorporation of low-cost, earth-abundant materials. In general, iron redox flow batteries (IFBs) rely on iron, salt, and water for electrolyte, thus including simple, earth-abundant, and inexpensive materials, and eliminating incorporation of harsh chemicals and reducing an environmental footprint thereof.

The IFB may include a positive (redox) electrode where a redox reaction occurs and a negative (plating) electrode where ferrous iron (Fe²⁺) in the electrolyte may be reduced and plated. Various side reactions may compete with the Fe²⁺ reduction, including proton reduction, iron corrosion, and iron plating oxidation:

H⁺+e⁻↔½H₂ (proton reduction) (1)

Fe⁰+2H⁺↔Fe²⁺+H₂ (iron corrosion) (2)

2Fe³⁺+Fe⁰↔3Fe²⁺ (iron plating oxidation) (3)

As most side reactions occur at the plating electrode, IFB cycling capabilities may be limited by available iron plating on the plating electrode. Exemplary attempts to ameliorate iron plating loss have focused on catalytic electrolyte rebalancing to address hydrogen (H₂) gas generation from equations (1) and (2) and electrolyte charge imbalances (e.g., excess Fe³⁺) from equation (3) by ion crossover via equation (4):

Fe³⁺+½H₂→Fe²⁺+H⁺ (electrolyte rebalancing) (4)

In some examples, the electrolyte rebalancing of equation (4) may be realized via a rebalancing cell configured as a fuel cell, where the H₂ gas and the electrolyte may come into contact with one another at catalyst surfaces while a direct current (DC) is applied across positive and negative electrode pairs. However, reliability issues may arise in fuel cells as a result of inadvertent reverse current spikes interrupting DC flow. In other examples, the rebalancing cell may have a trickle bed or a jelly roll reactor setup, either of which may similarly come into contact with the H₂ gas and the electrolyte at catalyst surfaces of the respective rebalancing cell.

In some examples, to achieve relatively high rebalancing performance with relatively low amounts of H₂ gas, a rebalancing cell may include a stack of electrode assemblies, each electrode assembly including positive and negative electrodes in face-sharing contact with one another such that the positive and negative electrodes may be continuously electrically conductive (e.g., at surfaces of the positive and negative electrodes in face-sharing contact). In additional or alternative examples, no electric current may be directed away from the rebalancing cell. In this way, electrolyte rebalancing in the rebalancing cell may be driven via internal electrical shorting of interfacing pairs of the positive and negative electrodes therein. Further, in some examples, the rebalancing cell may be configured to draw each of the liquid electrolyte and H₂ gas (e.g., via forced convection, gravity feeding, capillary action, etc.) therethrough. By managing electrolyte and H₂ gas flows in this way, in combination with the internal electrical shorting, the Fe³⁺ reduction rate of the rebalancing cell may be increased over conventional rebalancing cell setups (e.g., by a factor of 20 or more).

The surface of the negative electrode in the rebalancing cell requires a catalyst for equation (4) to be energetically favorable. Over time, the catalyst surface may adsorb anions from the electrolyte which in turn attracts cations creating a diffusion double layer at the catalyst surface. The diffusion double layer may prevent the desired reactants from reaching the catalyst surface, thus poisoning the catalyst and hindering performance of the rebalancing cell.

In one example, the above issues may be addressed by a redox flow battery system comprising one or more redox flow battery cells, a rebalancing cell receiving electrolyte from the one or more redox flow battery cells and configured to catalyze hydrogen reduction of metal cations, and a conductive coupler connecting the rebalancing cell to an external voltage source. The conductive coupler enables application of an ion-repelling potential to a stack of electrode assemblies of the rebalancing cell during operation of the redox flow battery system. In this way, the applied ion-repelling potential may disrupt formation of a diffusion double layer, thus maintaining a catalytic performance of the rebalancing cell.

As one example, the rebalancing cell may be fitted with conductive rods inserted between each of a plurality of electrode assemblies collectively forming the rebalancing cell. The conductive rods may establish an electrically conductive path through the rebalancing cell. A conductive coupler may be connected to a baseplate of the rebalancing cell and extend between the rebalancing cell and the external voltage source, the external voltage source coupled to a counter electrode located within an electrolyte tank. By connecting the conductive coupler to the rebalancing cell, the voltage potential may be applied to each of the plurality of electrode assemblies. The voltage potential may repel ions from a surface of a catalyst disposed on a negative electrode of the plurality of electrode assemblies, thus hindering the formation of the diffusion double layer at the catalyst surface. As such, catalyst performance degradation is mitigated.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including a battery cell with redox and plating electrodes fluidically coupled to an electrolyte management system.

FIG. 2A shows a first perspective view of a first example of a rebalancing cell including a stack of internally shorted electrode assemblies.

FIG. 2B shows a second perspective view of the rebalancing cell of FIG. 2A.

FIG. 3 shows an exploded view of an electrode assembly for the rebalancing cell of FIGS. 2A and 2B.

FIG. 4A shows an isometric view of a second example of a rebalancing cell, the rebalancing cell electrically coupled to an external voltage source.

FIG. 4B shows a cutaway view of the rebalancing cell of FIG. 4A.

FIG. 4C shows a detailed view of a region of the cutaway view of FIG. 4B.

FIG. 5 shows a schematic diagram of an electrolyte management system.

FIG. 6 shows a flow chart of an example of a method for maintaining a performance a rebalancing cell by applying an ion-repelling potential.

FIG. 7 shows a graph illustrating a performance of the rebalancing cell of FIG. 4A operated with and without an applied ion-repelling potential.

### DETAILED DESCRIPTION

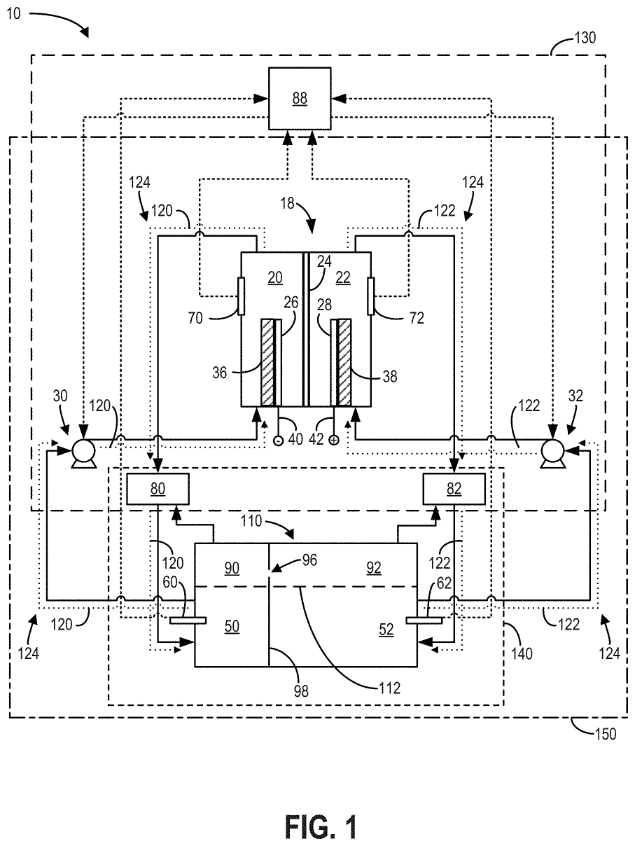

The following description relates to systems and methods for maintaining a performance of a catalyst of a rebalancing cell, the rebalancing cell driven via internal electrical shorting of electrode assemblies included therein. In an exemplary embodiment, the rebalancing cell may be fluidically coupled to an electrolyte subsystem, each included in an electrolyte management system of the redox flow battery system. The redox flow battery system is depicted schematically in FIG. 1 with an integrated multi-chambered tank having separate positive and negative electrolyte chambers (e.g., for respectively storing positive and negative electrolytes) and respective gas head spaces (e.g., for storing H₂ gas). In some examples, the redox flow battery system may include an all-iron flow battery (IFB) utilizing iron redox chemistry at both a positive (redox) electrode and the negative (plating) electrode of the IFB. The electrolyte chambers may be coupled to one or more battery cells, each cell including the positive and negative electrodes. Electrolyte may be pumped through positive and negative electrode compartments of the cells, the positive and negative electrode compartments housing the positive and negative electrodes, respectively.

In some examples, the redox flow battery system may include a hybrid redox flow battery. Hybrid redox flow batteries are redox flow batteries which may be characterized by deposition of one or more electroactive materials as a solid layer on an electrode (e.g., the negative electrode). Hybrid redox flow batteries may, for instance, include a chemical species which may plate via an electrochemical reaction as a solid on a substrate throughout a battery charge process. During battery discharge, the plated species may ionize via a further electrochemical reaction, becoming soluble in the electrolyte. In hybrid redox flow battery systems, a charge capacity (e.g., a maximum amount of energy stored) of the redox flow battery may be limited by an amount of metal plated during battery charge and may accordingly depend on an efficiency of the plating system as well as volume and surface area available for plating.

In some examples, electrolytic imbalances in the redox flow battery system may result from numerous side reactions competing with desired redox chemistry, including hydrogen (H₂) gas generating reactions such as proton reduction and iron corrosion:

H⁺+e⁻↔½H₂ (proton reduction) (1)

Fe⁰+2H⁺↔Fe²⁺+H₂ (iron corrosion) (2)

and charge imbalances from excess ferric iron (Fe³⁺) generated during oxidation of iron plating:

2Fe³⁺+Fe⁰↔3Fe²⁺ (iron plating oxidation) (3)

The reactions of equations (1) to (3) may limit iron plating and thereby decrease overall battery capacity. To address such imbalances, electrolyte rebalancing may be leveraged to both reduce Fe³⁺ and eliminate excess H₂ gas via a single redox reaction:

Fe³⁺+½H₂Fe²⁺+H⁺ (electrolyte rebalancing) (4)

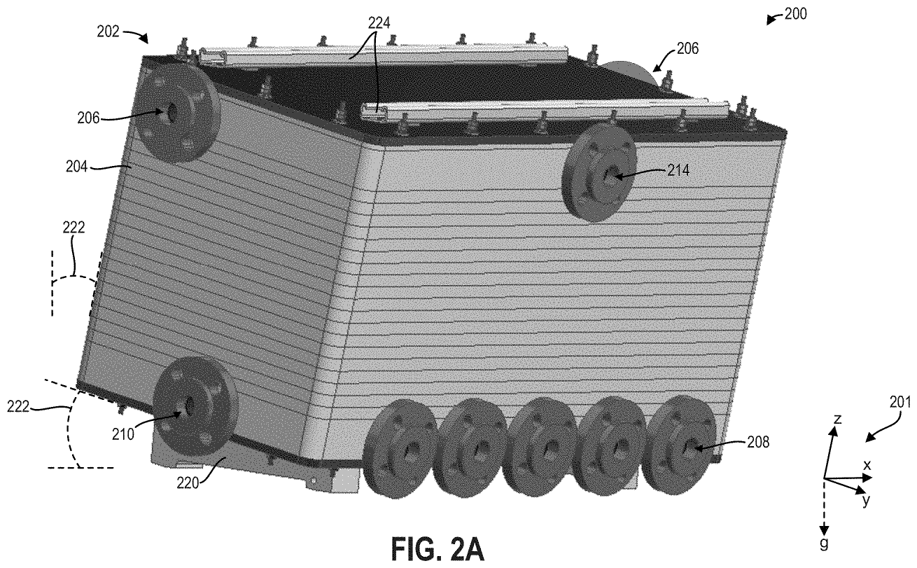

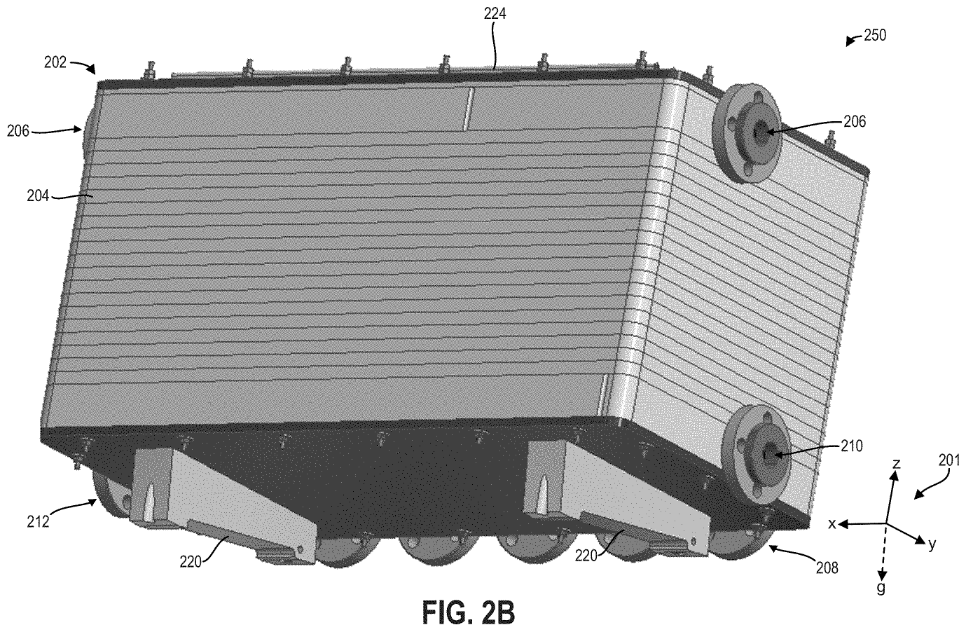

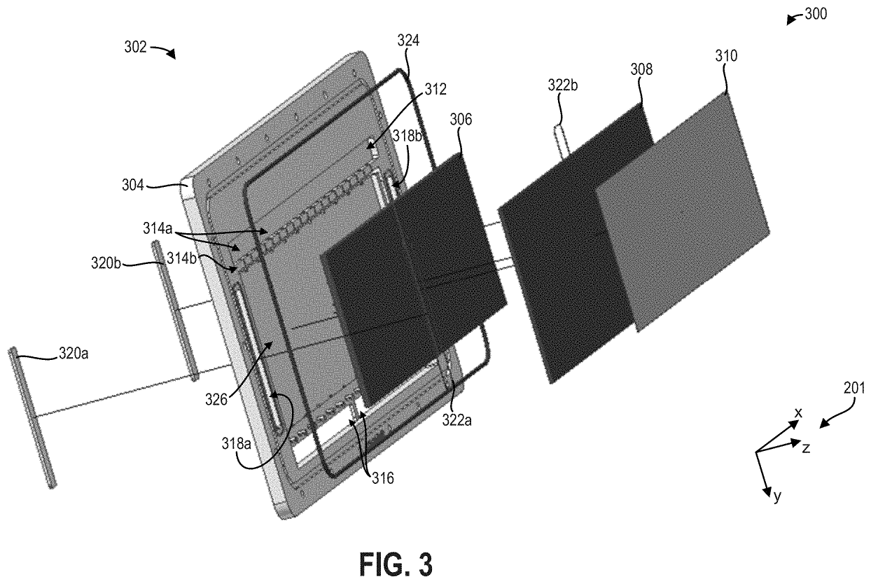

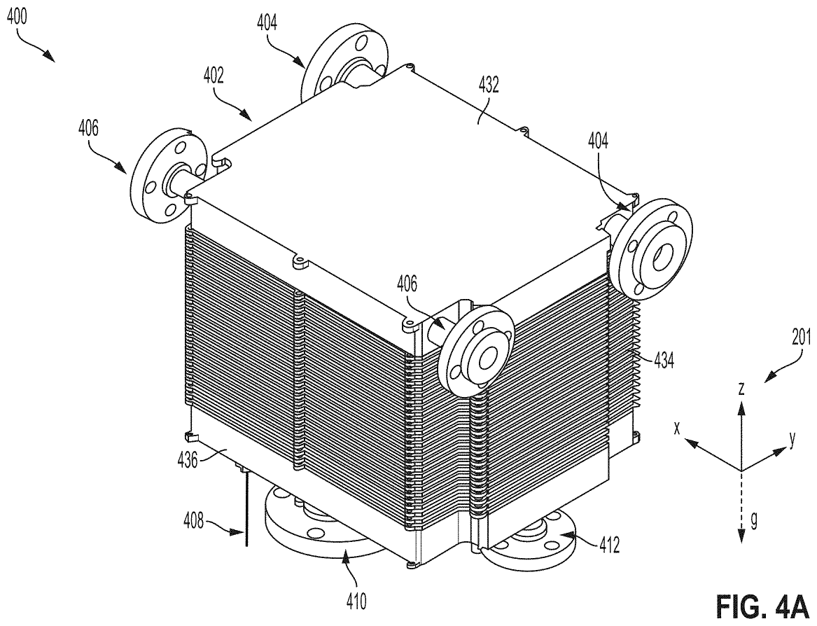

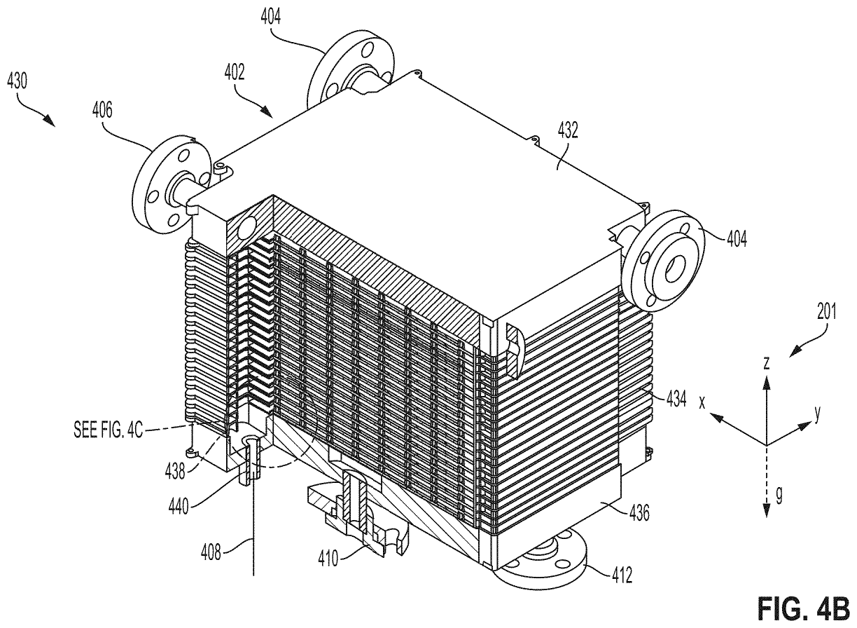

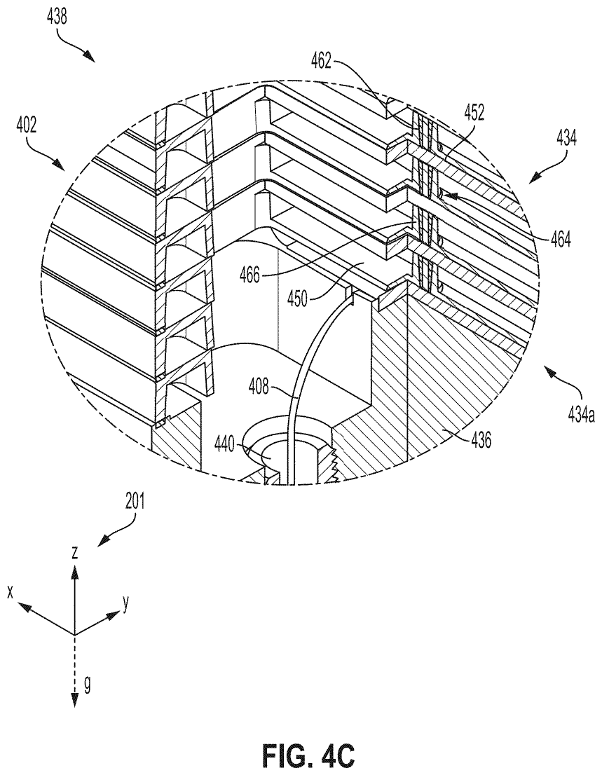

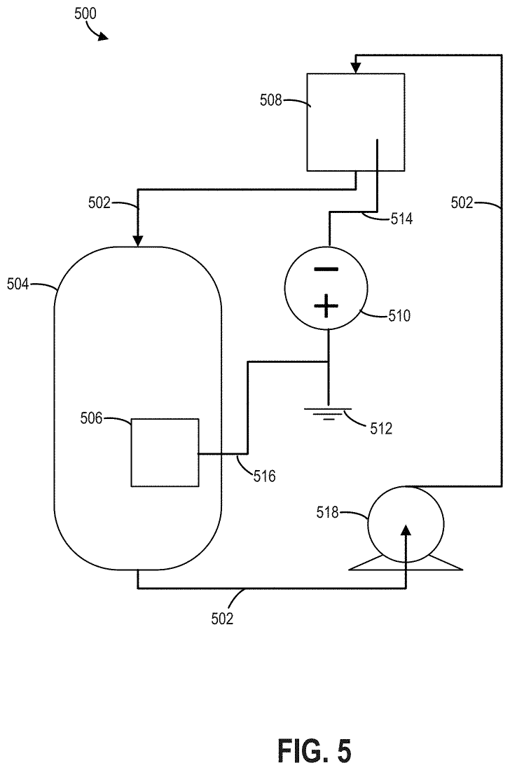

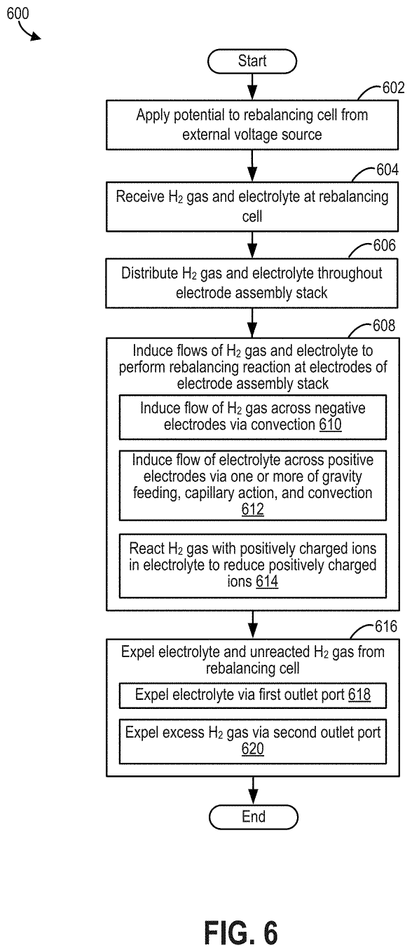

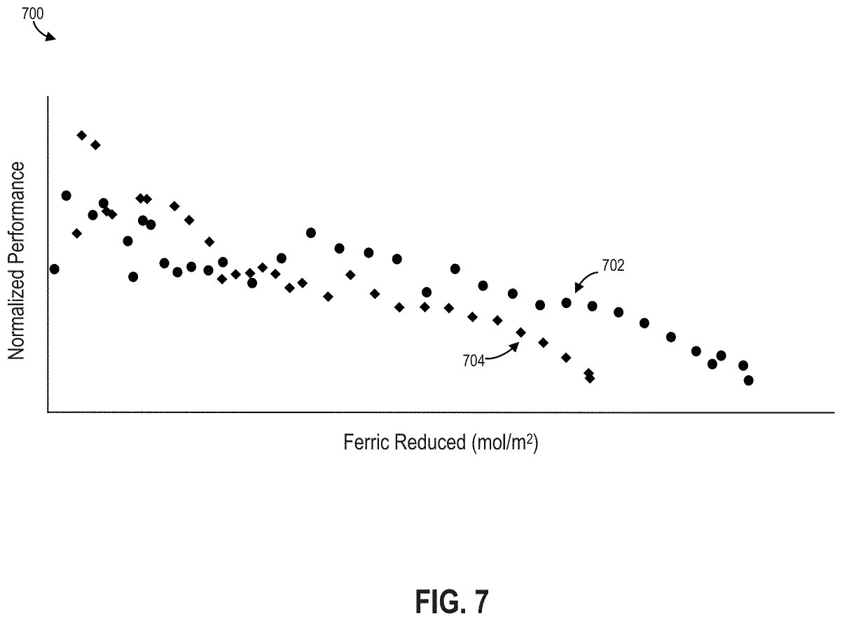

As described by embodiments herein, Fe³⁺ reduction rates sufficient for higher performance applications may be reliably achieved at lower H₂ gas partial pressures via a rebalancing cell of an electrolyte management system, such as a first exemplary rebalancing cell depicted in FIGS. 2A and 2B, including a stack of internally shorted electrode assemblies. An example of one of the electrode assemblies is shown in FIG. 3. A performance of the rebalancing cell, e.g., reduction rate, may be maintained by applying a voltage, e.g., an ion-repelling voltage or potential, across the electrode assemblies. FIGS. 4A-4C show a second example of a rebalancing cell of an electrolyte management system configured to connect a stack of electrode assemblies to an external voltage source. A schematic diagram of the electrolyte management system is shown in FIG. 5. An example of a method used for protecting the catalyst of a rebalancing cell is shown in FIG. 6. Experimental results comparing a performance of a rebalancing cell with the ion-repelling voltage applied and a rebalancing cell without the ion-repelling voltage applied are illustrated in FIG. 7.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe²⁺ gains an electron to form Fe²⁺ during battery discharge. The electrochemical reaction is summarized in equations (5) and (6), wherein the forward reactions (left to right) indicate electrochemical reactions during battery charge, while the reverse reactions (right to left) indicate electrochemical reactions during battery discharge:

Fe²⁺+2e⁻↔Fe⁰ −0.44 V (negative electrode) (5)

Fe²⁺↔2Fe³⁺+2e⁻ +0.77 V (positive electrode) (6)

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe²⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110 via an electrolyte flow path 124. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10 via the electrolyte flow path 124. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be included in an electrolyte management system 140 of the redox flow battery system 10 and an interior volume of the multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors, or rebalancing cells, 80 and 82, such that the rebalancing reactors or cells 80 and 82 may be respectively fluidically coupled to the gas head spaces 90 and 92. The rebalancing reactors/cells 80 and 82 may also be included in the electrolyte management system 140, in addition to components fluidically coupling the rebalancing reactors/cells 80, 82 to the multi-chambered electrolyte storage tank 110 and devices driving electrolyte flow therethrough.

As shown, the electrolyte flow path 124 may fluidically couple the integrated multi-chambered electrolyte storage tank 110 to the redox flow battery cell 18 and each of the rebalancing reactors/cells 80 and 82. In some examples, the electrolyte flow path 124 may be a closed flow path in the sense that, during operation of the redox flow battery system 10, the negative and positive electrolytes may be circulated through only one redox flow battery cell 18 along the electrolyte flow path without entering any other redox flow battery cell or being otherwise expelled from the redox flow battery system 10. In such examples, when the redox flow battery system 10 includes a plurality of redox flow battery cells 18, a plurality of (closed) electrolyte flow paths 124 may be included in the redox flow battery system 10, a number of the plurality of electrolyte flow paths 124 being equivalent to a number of the plurality of redox flow battery cells 18. In this way, each of the redox flow battery cells 18 may be fluidically isolated from one another, thereby eliminating stack-to-stack shunting via the negative and positive electrolytes. In other examples, the redox flow battery system 10 may include the plurality of redox flow battery cells 18 fluidically coupled to one another via the electrolyte flow path 124.

The electrolyte flow path 124 may include a negative electrolyte flow loop 120 and a positive electrolyte flow loop 122, where the negative and positive electrolytes may be cycled through the negative and positive electrolyte flow loops 120 and 122, respectively. The negative and positive electrolyte flow loops 120 and 122 may be fully or almost fully fluidically decoupled from one another (e.g., fluidic coupling may occur only via the spillover hole 96, when included in the bulkhead 98 of the integrated multi-chambered electrolyte storage tank 110).

As shown, the negative electrolyte flow loop 120 may sequentially cycle the negative electrolyte through the negative electrolyte chamber 50 of the integrated multi-chambered electrolyte storage tank 110, the negative electrolyte pump 30, the negative electrode compartment 20 of the redox flow battery cell 18, and the (negative) rebalancing reactor/cell 80, flowing therefrom back to the negative electrolyte chamber 50 of the integrated multi-chambered electrolyte storage tank 110. As further shown, the positive electrolyte flow loop 122 may sequentially the positive electrolyte pass through the positive electrolyte chamber 52 of the integrated multi-chambered electrolyte storage tank 110, the positive electrolyte pump 32, the positive electrode compartment 22 of the redox flow battery cell 18, and the (positive) rebalancing reactor/cell 82, flowing therefrom back to the positive electrolyte chamber 52 of the integrated multi-chambered electrolyte storage tank 110. Accordingly, electrolyte solutions primarily stored in the multi-chambered electrolyte storage tank 110 may be pumped via the negative and positive electrolyte pumps 30 and 32 throughout the redox flow battery system 10: electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18. In this way, during operation of the redox flow battery system 10, the negative and positive electrolytes may be cycled through the redox flow battery cell 18 largely independently of one another via the negative and positive electrolyte flow loops 120 and 122, respectively.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together.

For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

The electrolyte rebalancing reactors/cells 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors/cells 80 and 82 may be placed in a return flow path from the negative and positive electrode compartments 20 and 22 to the negative and positive electrolyte chambers 50 and 52, respectively. The electrolyte rebalancing reactors/cells 80 and 82 may serve to rebalance electrolyte charge imbalances in the redox flow battery system 10 occurring due to side reactions, ion crossover, and the like, as described herein.

To increase the Fe³⁺ reduction rate without sacrificing an overall reliability of the rebalancing reactors/cells 80 and 82, embodiments of the present disclosure provide a rebalancing cell, examples of which are shown in FIGS. 2A and 2B, and FIGS. 4A-4C, that includes a stack of internally shorted electrode assemblies, with an example of an internally electrode assembly shown in FIG. 3. The rebalancing cell may be configured to drive the H₂ gas and the electrolyte to react at catalyst surfaces via a combination of internal electric current, convection, gravity feeding, and capillary action. In embodiments described herein, the electrode assemblies of the stack of internally shorted electrode assemblies may be referred to as “internally shorted,” in that no electric current may be directed away from the stack of internally shorted electrode assemblies during operation of the rebalancing cell. Such internal electrical shorting may reduce or obviate reverse current spikes while drastically increasing the Fe³⁺ reduction rate (e.g., to as high as −50-70 mol/m² hr, or by a factor of 20 or more relative to rebalancing reactor configurations which are not internally electrically shorted) and concomitantly decreasing side reaction rates (e.g., rates of the reactions of equations (1)-(3)). Further, each electrode assembly of the stack of internally shorted electrode assemblies may be electrically decoupled from other electrode assemblies of the stack of internally shorted electrode assemblies such that degradation to the stack of internally shorted electrode assemblies during a current spike at one electrode assembly may be limited thereto (e.g., reverse electric current may not be driven from one electrode assembly through the other electrode assemblies). In such cases, the single, degraded electrode assembly may be easily removed from the stack of internally shorted electrode assemblies and replaced with a non-degraded electrode assembly.

To realize the internally shorted circuit, each electrode assembly of the stack of internally shorted electrode assemblies may include an interfacing pair of positive and negative electrodes (e.g., configured in face-sharing contact with one another so as to be continuously electrically conductive). As used herein, a pair of first and second components (e.g., positive and negative electrodes of an electrode assembly) may be described as “interfacing” with one another when the first component is arranged adjacent to the second component such that the first and second components are in face-sharing contact with one another (where “adjacent” is used herein to refer to any two components having no intervening components therebetween). Further, as used herein, “continuously” when describing electrical conductivity of multiple electrodes may refer to an electrical pathway therethrough having effectively or practically zero resistance at any face-sharing interfaces of the multiple electrodes.

In an exemplary embodiment, the (positive) rebalancing reactor/cell 82 of FIG. 1 may be the rebalancing cell including the stack of internally shorted electrode assemblies. Higher Fe³⁺ reduction rates may be desirable to rebalance the positive electrolyte, as Fe³⁺ may be generated at the positive electrode 28 during battery charging (see equation (6)). In additional or alternative embodiments, the (negative) rebalancing reactor/cell 80 may be of like configuration [Fe³⁺ may be generated at the negative electrode 26 during iron plating oxidation (see equation (3))].

Fe³⁺ reduction rates may degrade over time due to a decrease in catalytic activity at the negative electrode of the rebalancing cell. Such a decrease has been attributed to the formation of a diffusion double layer over the catalyst at the negative electrode of the rebalancing cell during operation of the redox flow battery system, leading to adsorption of anions at the catalyst surface which then causes an additional layer of cations surrounding the catalyst. The diffusion double layer may therefore inactivate the catalyst by blocking interaction between the catalyst and iron cations. Application of a voltage (e.g., an ion-repelling voltage potential) to the rebalancing cell from an external voltage source may inhibit generation of the diffusion double layer. An example of a rebalancing cell coupled to an external voltage source is shown in FIGS. 4A-4C and described further below.

During operation of the redox flow battery system 10, sensors and probes may monitor and control chemical properties of the electrolyte such as electrolyte pH, concentration, SOC, and the like. For example, as illustrated in FIG. 1, sensors 62 and 60 may be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors/cells 80 and 82.

As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate (e.g., the Fe³⁺ reduction rate) is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, where the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, and as discussed in detail below with reference to FIG. 6, the controller may control the ion-repelling voltage applied to a rebalancing cell. In doing so, formation of a diffusion double layer at catalysts of the rebalancing cell may be circumvented, thereby maintaining a performance of the rebalancing cell. As another example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe²⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 130. As such, the redox flow battery system 10 may be described as including the power module 130 fluidly coupled to the integrated multi-chambered electrolyte storage tank 110 and communicably coupled to the sensors 60 and 62. In some examples, each of the power module 130 and the multi-chambered electrolyte storage tank 110 may be included in a single housing or packaging (not shown), such that the redox flow battery system 10 may be contained as a single unit in a single location. It will further be appreciated the positive electrolyte, the negative electrolyte, the sensors 60 and 62, the electrolyte rebalancing reactors/cells 80 and 82, and the integrated multi-chambered electrolyte storage tank 110 (and components included therein) may be considered as being included in the electrolyte management system 140. As such, the electrolyte management system 140 may supply one or more electrolytes to the redox flow battery cell 18 (and components included therein).

In some examples, and as discussed above, the redox flow battery system 10 may be configured as a redox flow battery pack including a plurality of fluidically isolated redox flow battery subsystems 150. In such examples, each of the plurality of fluidically isolated redox flow battery subsystems 150 may include all components of the redox flow battery system 10 apart from the controller 88. More specifically, each of the plurality of fluidically isolated redox flow battery subsystems 150 may, in one example, include a separate integrated multi-chambered electrolyte storage tank 110, separate electrolyte pumps 30 and 32, a separate redox flow battery cell 18, separate rebalancing reactors/cells 80 and 82, etc. Accordingly, each of the plurality of fluidically isolated redox flow battery subsystems 150 may be referred to herein as a redox flow battery, where each redox flow battery may be independently configured to output electrical power during discharge. In such configurations, the controller 88 may be communicably coupled to each of the redox flow batteries and may therefore control operating states of each of the redox flow batteries in tandem or individually, as determined based on a given application.

Referring now to FIGS. 2A and 2B, a first perspective view 200 and a second perspective view 250 are shown, respectively, of a rebalancing cell 202 for a redox flow battery system, such as redox flow battery system 10 of FIG. 1. In an exemplary embodiment, the rebalancing cell 202 may include a stack of internally shorted electrode assemblies, such as an electrode assembly described in detail below with reference to FIG. 3. An example of stacks of internally shorted electrode assemblies of a rebalancing cell is illustrated in FIGS. 4A-4C. The rebalancing cell 202 may enable an electrolyte rebalancing reaction to occur by allowing H₂ gas to contact an electrolyte from positive or negative electrode compartments of a redox flow battery, such as the redox flow battery cell 18 of FIG. 1, at catalytic surfaces of negative electrodes of the stack of internally shorted electrode assemblies. Accordingly, the rebalancing cell 202 may be one or both of the rebalancing reactors/cells 80 and 82 of FIG. 1. A set of reference axes 201 is provided for describing relative positioning of the components shown and for comparison between the views of FIGS. 2A-4C, the axes 201 indicating an x-axis, a y-axis, and a z-axis. As further shown in dashing in FIGS. 2A and 2B, an additional axis g may be parallel with a direction of gravity (e.g., in a positive direction along the axis g) and a vertical direction (e.g., in a negative direction along the axis g and opposite to the direction of gravity).

A number of the rebalancing cell 202 included in the redox flow battery system and a number of electrode assemblies included in the stack of internally shorted electrode assemblies are not particularly limited and may be increased to accommodate correspondingly higher performance applications. For example, a 75 kW redox flow battery system may include two rebalancing cells 202, each including a stack of 20 electrode assemblies (e.g., a stack of 19 bipolar assemblies with 2 endplates positioned at opposite ends of the stack).

As shown, the stack of internally shorted electrode assemblies may be removably enclosed within a housing or external cell enclosure 204. Accordingly, in some examples, the cell enclosure 204 may include a top cover removably affixed to an enclosure base, such that the top cover may be temporarily removed to replace or diagnose one or more electrode assemblies of the stack of internally shorted electrode assemblies. In additional or alternative examples, the cell enclosure 204, depicted in FIGS. 2A and 2B as a rectangular prism, may be molded to be clearance fit against other components of the redox flow battery system such that the rebalancing cell 202 may be in face-sharing contact with such components. In some examples, the cell enclosure 204 may be composed of a material having a low electrical conductivity, such as a plastic or other polymer, so as to reduce undesirable shorting events.

The cell enclosure 204 may further be configured to include openings or cavities for interfacial components of the rebalancing cell 202. For example, the cell enclosure 204 may include a plurality of inlet and outlet ports configured to fluidically couple to other components of the redox flow battery system. In one example, and as shown, the plurality of inlet and outlet ports may include polypropylene (PP) flange fittings fusion welded to PP plumbing.

In an exemplary embodiment, the plurality of inlet and outlet ports may include an electrolyte inlet port 206 for flowing the electrolyte into the cell enclosure 204 and an electrolyte outlet port 208 for expelling the electrolyte from the cell enclosure 204. In one example, the electrolyte inlet port 206 may be positioned on an upper half of the cell enclosure 204 and the electrolyte outlet port 208 may be positioned on a lower half of the cell enclosure 204 (where the upper half and the lower half of the cell enclosure 204 are separated along the z-axis by a plane parallel with each of the x- and y-axes). Accordingly, the electrolyte outlet port 208 may be positioned lower than the electrolyte inlet port 206 with respect to the direction of gravity (e.g., along the axis g).

Specifically, upon the electrolyte entering the cell enclosure 204 via the electrolyte inlet port 206, the electrolyte may be distributed across the stack of internally shorted electrode assemblies, gravity fed through the stack of electrode assemblies, wicked up (e.g., against the direction of gravity) through positive electrodes of the stack of internally shorted electrode assemblies to react at the catalytic surfaces of the negative electrodes in a cathodic half reaction, and expelled out of the cell enclosure 204 via the electrolyte outlet port 208. To assist in the gravity feeding of the electrolyte and decrease a pressure drop thereof, the rebalancing cell 202 may further be tilted or inclined with respect to the direction of gravity via a sloped support 220 coupled to the cell enclosure 204. In some examples, tilting of the cell enclosure 204 in this way may further assist in electrolyte draining of the rebalancing cell 202 (e.g., during an idle mode of the redox flow battery system) and keep the catalytic surfaces relatively dry (as the catalytic surfaces may corrode after being soaked in the electrolyte for a sufficient duration, in some examples).

As shown, the sloped support 220 may tilt the cell enclosure 204 at an angle 222 such that planes of electrode sheets of the stack of internally shorted electrode assemblies are inclined with respect to a lower surface (not shown) on which the sloped support 220 rests at the angle 222. In some examples, the angle 222 (e.g., of the cell enclosure 204 with respect to the lower surface) may be between 0° and 30° (in embodiments wherein the angle 222 is substantially 0°, the rebalancing cell 202 may still function, though the pressure drop may be greater and electrolyte crossover to the negative electrodes may be reduced when the cell enclosure 204 is tilted). In some examples, the angle 222 may be between 2° and 30°. In some examples, the angle 222 may be between 2° and 20°. In one example, the angle 222 may be about 8°. Accordingly, the pressure drop of the electrolyte may be increased by increasing the angle 222 and decreased by decreasing the angle 222. Additionally or alternatively, one or more support rails 224 may be coupled to the upper half of the cell enclosure 204 (e.g., opposite from the sloped support 220). In some examples, and as shown in the perspective view 200 of FIG. 2A, the one or more support rails 224 may be tilted with respect to the cell enclosure 204 at the angle 222 such that the one or more support rails 224 may removably fasten the rebalancing cell 202 to an upper surface above and parallel with the lower surface. In this way, and based on geometric considerations, the z-axis may likewise be offset from the axis g at the angle 222 (e.g., the cell enclosure 204 may be tilted with respect to a vertical direction opposite the direction of gravity by the angle 222, as shown in FIGS. 2A and 2B). In some examples, gravity feeding of the electrolyte through the rebalancing cell 202 may further be assisted by positioning the rebalancing cell 202 above an electrolyte storage tank (e.g., the multi-chambered electrolyte storage tank 110 of FIG. 1) of the redox flow battery system with respect to the vertical direction opposite to the direction of gravity.

As further shown, the electrolyte outlet port 208 may include a plurality of openings in the cell enclosure 204 configured to expel at least a portion of the electrolyte (each of the plurality of openings including the PP flange fitting fusion welded to PP plumbing). For instance, in FIGS. 2A and 2B, the electrolyte outlet port 208 is shown including five openings. In this way, the electrolyte may be evenly distributed across the stack of internally shorted electrode assemblies and may be expelled from the cell enclosure 204 with substantially unimpeded flow. In other examples, the electrolyte outlet port 208 may include more than five openings or less than five openings. In one example, the electrolyte outlet port 208 may include only one opening. In additional or alternative examples, the electrolyte outlet port 208 may be positioned beneath the cell enclosure 204 with respect to the z-axis (e.g., on a face of the cell enclosure 204 facing a negative direction of the z-axis).

The electrolyte inlet port 206 and the electrolyte outlet port 208 may be positioned on the cell enclosure 204 based on a flow path of the electrolyte through the stack of internally shorted electrode assemblies (e.g., from the electrolyte inlet port 206 to the electrolyte outlet port 208 and inclusive of channels, passages, plenums, wells, etc. within the cell enclosure 204 fluidically coupled to the electrolyte inlet port 206 and the electrolyte outlet port 208). In some examples, and as shown, the electrolyte inlet port 206 and the electrolyte outlet port 208 may be positioned on adjacent sides of the cell enclosure 204 (e.g., faces of the cell enclosure 204 sharing a common edge). In other examples, the electrolyte inlet port 206 and the electrolyte outlet port 208 may be positioned on opposite sides of the cell enclosure 204. In other examples, the electrolyte inlet port 206 and the electrolyte outlet port 208 may be positioned on the same side of the cell enclosure 204.

In some examples, the electrolyte inlet port 206 may be positioned on a face of the cell enclosure 204 facing a negative direction of the x-axis. In additional or alternative examples, the electrolyte inlet port 206 may be positioned on a face of the cell enclosure 204 facing a positive direction of the x-axis. In one example, and as shown, one opening of the electrolyte inlet port 206 may be positioned on the face of the cell enclosure 204 facing the negative direction of the x-axis and another opening of the electrolyte inlet port 206 may be positioned on the face of the cell enclosure 204 facing the positive direction of the x-axis.

In some examples, the plurality of inlet and outlet ports may further include a hydrogen gas inlet port 210 for flowing the H₂ gas into the cell enclosure 204 and a hydrogen gas outlet port 212 (as shown in FIG. 2B) for expelling the H₂ gas from the cell enclosure 204. In one example, and as shown, each of the hydrogen gas inlet port 210 and the hydrogen gas outlet port 212 may be positioned on the lower half of the cell enclosure 204 (e.g., at a lowermost electrode assembly of the stack of internally shorted electrode assemblies along the z-axis). In another example, each of the hydrogen gas inlet port 210 and the hydrogen gas outlet port 212 may be positioned on the upper half of the cell enclosure 204 (e.g., at an uppermost electrode assembly of the stack of internally shorted electrode assemblies along the z-axis). In yet another example, the hydrogen gas inlet port 210 may be positioned on the lower half of the cell enclosure 204 and the hydrogen gas outlet port 212 may be positioned on the upper half of the cell enclosure 204. In such an example, the hydrogen gas inlet port 210 may be positioned lower than the hydrogen gas outlet port 212 with respect to the direction of gravity (e.g., along the axis g).

Specifically, upon the H₂ gas entering the cell enclosure 204 via the hydrogen gas inlet port 210, the H₂ gas may be distributed across and through the stack of internally shorted electrode assemblies via forced convection (e.g., induced by flow field configurations of respective flow field plates) and decomposed at the catalytic surfaces of the negative electrodes in an anodic half reaction. However, in some examples, excess, unreacted H₂ gas may remain in the rebalancing cell 202 following contact with the catalytic surfaces. In some examples, at least a portion of the H₂ gas which has not reacted at the catalytic surfaces may pass into the electrolyte. To avoid undesirable pressure buildup and thereby prevent electrolyte pooling on the positive electrodes and concomitant electrolyte flooding of the negative electrodes in such examples, the plurality of inlet and outlet ports may further include a pressure release outlet port 214 to expel unreacted H₂ gas from the electrolyte. Further, in some examples, the hydrogen gas outlet port 212 may be configured to expel at least a portion of the H₂ gas which has not reacted at the catalytic surfaces and that has not flowed through the negative electrodes into the electrolyte.

The hydrogen gas inlet port 210 and the hydrogen gas outlet port 212 may be positioned on the cell enclosure 204 based on a flow path of the H₂ gas through the stack of internally shorted electrode assemblies [e.g., from the hydrogen gas inlet port 210 to the hydrogen gas outlet port 212 (when included) and inclusive of channels, passages, plenums, etc. within the cell enclosure 204 fluidically coupled to the hydrogen gas inlet port 210 and the hydrogen gas outlet port 212 (when included)]. In some examples, and as shown, the hydrogen gas inlet port 210 and the hydrogen gas outlet port 212 may be positioned on opposite sides of the cell enclosure 204. In other examples, the hydrogen gas inlet port 210 and the hydrogen gas outlet port 212 may be positioned on adjacent sides of the cell enclosure 204. In other examples, the hydrogen gas inlet port 210 and the hydrogen gas outlet port 212 may be positioned on the same side of the cell enclosure 204. Further, though the hydrogen gas inlet port 210 is shown in FIGS. 2A and 2B as being positioned on the face of the cell enclosure 204 facing the negative direction of the x-axis and the hydrogen gas outlet port 212 is shown in FIGS. 2A and 2B as being positioned on the face of the cell enclosure 204 facing the positive direction of the x-axis, in other examples, the hydrogen gas inlet port 210 may be positioned on the face of the cell enclosure 204 facing the positive direction of the x-axis and the hydrogen gas outlet port 212 may be positioned on the face of the cell enclosure 204 facing the negative direction of the x-axis.

In one example, the hydrogen gas inlet port 210, the hydrogen gas outlet port 212, the electrolyte inlet port 206, and the electrolyte outlet port 208 may be positioned on the cell enclosure 204 in a crosswise configuration. Specifically, the crosswise configuration may include the hydrogen gas outlet port 212 and the electrolyte inlet port 206 being positioned on different sides (e.g., faces) of the upper half of the cell enclosure 204 and the hydrogen gas inlet port 210 and the electrolyte outlet port 208 being positioned on different sides of the lower half of the cell enclosure 204.

In other examples, no hydrogen gas outlet port 212 may be present for expelling H₂ gas which has not reacted at the catalytic surfaces of the negative electrodes and which has not flowed through the negative electrodes into the electrolyte. In such examples, however, the pressure release outlet port 214 for expelling unreacted H₂ gas from the electrolyte may still be present, and the unreacted H₂ gas may only be expelled from the cell enclosure 204 after flowing through the negative electrodes into the electrolyte and through the pressure release outlet port 214. Exemplary rebalancing cell configurations lacking the hydrogen gas outlet port 212, whether or not including the pressure release outlet port 214, may be referred to as “dead ended configurations.” In dead ended configurations, substantially all of the H₂ gas may be forced into contact with the catalytic surfaces of the negative electrodes, whereat the H₂ gas may either decompose via the anodic half reaction and/or the H₂ gas may enter the electrolyte after passing through the negative electrodes (e.g., without reacting at catalytic surfaces thereof).

Referring now to FIG. 3, an exploded view 300 depicting an electrode assembly 302 for a rebalancing cell, such as the rebalancing cell 202 of FIGS. 2A and 2B, as well as of FIGS. 4A-4C, is shown. Accordingly, the electrode assembly 302 may be internally shorted (e.g., electric current flowing through the electrode assembly 302 is not channeled through an external load). In an exemplary embodiment, the electrode assembly 302 may be included in a stack of electrode assemblies of like configuration in a cell enclosure so as to form the rebalancing cell. The electrode assembly 302 may include a plate 304 with an activated carbon foam 306, a positive electrode 308 (also referred to herein as a “cathode” in certain examples), and a negative electrode 310 (also referred to herein as an “anode” in certain examples) sequentially stacked thereon. In one example, the plate 304 may be a bipolar plate. The electrode assembly 302 may be positioned within the rebalancing cell so as to receive an electrolyte through the carbon foam 306, wherefrom the electrolyte may enter pores of the positive electrode 308 via capillary action and come into contact with the negative electrode 310. The electrode assembly 302 may further be positioned within the rebalancing cell so as to receive H₂ gas across a catalytic surface of the negative electrode 310 opposite to the positive electrode 308 via convection. The convection of the H₂ gas across the catalytic surface may be assisted by a flow field plate (not shown at FIG. 3) interfacing with the catalytic surface. Upon decomposition of the H₂ gas at the catalytic surface via an anodic half reaction, protons and electrons may flow to an interface of the negative electrode 310 and the positive electrode 308, whereat ions in the electrolyte may be reduced via a cathodic half reaction (e.g., Fe³⁺ may be reduced to Fe²⁺). In this way, the electrode assembly 302 may be configured for electrolyte rebalancing for a redox flow battery, such as the redox flow battery cell 18 of FIG. 1, fluidically coupled to the rebalancing cell including the electrode assembly 302.

In some examples, the plate 304 may be composed of a material having a low electrical conductivity, such as a plastic or other polymer, so as to reduce undesirable shorting events. Accordingly, in one example, the plate 304 may be formed from the same material as the cell enclosure 204 of FIGS. 2A and 2B.

As shown, the plate 304 may include a plurality of inlets and outlets therethrough. For example, the plurality of inlets and outlets may include an electrolyte outlet channel section 316, a hydrogen gas inlet channel section 318a, and a hydrogen gas outlet channel section 318b. Specifically, the plate 304 may include the electrolyte outlet channel section 316 for directing the electrolyte out of the rebalancing cell, the hydrogen gas inlet channel section 318a for directing the H₂ gas into the rebalancing cell and across the negative electrode 310, and the hydrogen gas outlet channel section 318b for directing the H₂ gas out of the rebalancing cell. The plate 304 may further include an electrolyte inlet well 312 for receiving the electrolyte at the electrode assembly 302, the electrolyte inlet well 312 fluidically coupled to a plurality of electrolyte inlet passages 314a set into a berm 314b positioned adjacent to the carbon foam 306 for distributing the received electrolyte across the carbon foam 306. In some examples, the electrolyte inlet well 312 may receive the electrolyte from an electrolyte inlet port (e.g., the electrolyte inlet port 206 of FIGS. 2A and 2B) fluidically coupled thereto (e.g., via an electrolyte inlet channel; not shown at FIG. 3), the electrolyte outlet channel section 316 may expel the electrolyte through an electrolyte outlet port (e.g., the electrolyte outlet port 208 of FIGS. 2A and 2B) fluidically coupled thereto, the hydrogen gas inlet channel section 318a may receive the H₂ gas from a hydrogen gas inlet port (e.g., the hydrogen gas inlet port 210 of FIGS. 2A and 2B) fluidically coupled thereto, and the hydrogen gas outlet channel section 318b may expel the H₂ gas through a hydrogen gas outlet port (e.g., the hydrogen gas outlet port 212 of FIGS. 2A and 2B) fluidically coupled thereto.

It will be appreciated that, though the hydrogen gas inlet channel section 318a is described herein as a section of a hydrogen gas inlet channel and the hydrogen gas outlet channel section 318b is described herein as a section of a hydrogen gas outlet channel, in other examples, the channel section 318b may be a section of a hydrogen gas inlet channel (e.g., for directing the H₂ gas into the rebalancing cell and across the negative electrode 310 after receiving the H₂ gas from the hydrogen gas inlet port) and the channel section 318a may be a section of a hydrogen gas outlet channel (e.g., for directing the H₂ gas out of the rebalancing cell by expelling the H₂ gas through the hydrogen gas outlet port). In other examples, the rebalancing cell may have a dead ended configuration and no hydrogen gas outlet port may be fluidically coupled to the hydrogen gas outlet channel section 318b. In such examples, the hydrogen gas outlet channel section 318b may direct the H₂ gas back across the negative electrode 310 or the hydrogen gas outlet channel section 318b may instead be configured as another hydrogen gas inlet channel section (e.g., for directing a portion of the H₂ gas into the rebalancing cell and across the negative electrode 310 after receiving the portion of the H₂ gas from the hydrogen gas inlet port).

The plurality of inlets and outlets may be configured to control electrolyte and H₂ gas flow throughout the rebalancing cell. As an example, a size of each of the hydrogen gas inlet channel section 318a and the hydrogen gas outlet channel section 318b may be selected to minimize a pressure drop therethrough, thereby aiding in flow distribution into each electrode assembly 302 of the stack of internally shorted electrode assemblies. As another example, a size of each electrolyte inlet passage 314a and a total number of the plurality of electrolyte inlet passages 314a relative to the berm 314b may be selected to induce a relatively small pressure drop to substantially evenly distribute electrolyte flow. In such an example, the selection of the size of each electrolyte inlet passage 314a and the total number of the plurality of electrolyte inlet passages 314a may be dependent on a number of factors specific to a given configuration of the rebalancing cell, such as a size of an electrolyte flow field and a desired electrolyte flow rate.

In additional or alternative examples, the electrolyte outlet channel section 316 may further be configured for distributing the electrolyte through multiple openings included in the electrolyte outlet port. For instance, in the exploded view 300 of FIG. 3, the electrolyte outlet channel section 316 is shown including two openings. In some examples, a number of openings included in the electrolyte outlet channel section 316 may be equal to a number of openings included in the electrolyte outlet port, such that the openings of the electrolyte outlet channel section 316 may respectively correspond to the openings of the electrolyte outlet port. In this way, the electrolyte may be evenly distributed across the electrode assembly 302 and may be expelled from the rebalancing cell with substantially unimpeded flow. In other examples, the electrolyte outlet channel section 316 may include more than two openings or less than two openings (e.g., only one opening).

Further, when the electrode assembly 302 is included in a stack of electrode assemblies, electrolyte outlet channel sections 316, hydrogen gas inlet channel sections 318a, and hydrogen gas outlet channel sections 318b may align to form a continuous electrolyte outlet channel, a continuous hydrogen gas inlet channel, and a continuous hydrogen gas outlet channel, respectively). In this way, the stack of electrode assemblies may be formed in a modular fashion, whereby any practical number of electrode assemblies 302 may be stacked and included in a rebalancing cell.

As further shown, a plurality of sealing inserts may be affixed (as used herein, “affix,” “affixed,” or “affixing” includes, but is not limited to, gluing, attaching, connecting, fastening, joining, linking, or securing one component to another component through a direct or indirect relationship) or otherwise coupled to the plate 304. As an example, the plurality of sealing inserts may include a hydrogen gas inlet channel seal insert 320a and a hydrogen gas outlet channel seal insert 320b for inducing flow of the H₂ gas across the negative electrode 310 by mitigating H₂ gas bypass. Specifically, the hydrogen gas inlet channel seal insert 320a and the hydrogen gas outlet channel seal insert 320b may be affixed or otherwise coupled adjacent to the hydrogen gas inlet channel section 318a and the hydrogen gas outlet channel section 318b, respectively, on a side of the plate 304 including the carbon foam 306, the positive electrode 308, and the negative electrode 310. In some examples, the hydrogen gas inlet channel seal insert 320a and the hydrogen gas outlet channel seal insert 320b may be coincident with an x-y plane of the negative electrode 310 such that the hydrogen gas inlet channel seal insert 320a and the hydrogen gas outlet channel seal insert 320b may extend from a locus of affixation or coupling with the plate 304 and partially overlap the positive electrode 308.

As another example, the plurality of sealing inserts may further include each of a hydrogen gas inlet channel O-ring 322a and a hydrogen gas outlet channel O-ring 322b for respectively sealing an interface of the hydrogen gas inlet channel section 318a with a hydrogen gas inlet channel section of another electrode assembly and an interface of the hydrogen gas outlet channel section 318b with a hydrogen gas outlet channel section of another electrode assembly. Specifically, the hydrogen gas inlet channel O-ring 322a and the hydrogen gas outlet channel O-ring 322b may be affixed or otherwise coupled to the plate 304 so as to respectively circumscribe the hydrogen gas inlet channel section 318a and the hydrogen gas outlet channel section 318b.

As another example, the plurality of sealing inserts may further include an overboard O-ring 324 for sealing an interface of the electrode assembly 302 with another electrode assembly at outer edges thereof. Specifically, the overboard O-ring 324 may be affixed or otherwise coupled to the plate 304 so as to circumscribe each of the electrolyte inlet well 312, the plurality of electrolyte inlet passages 314a, the berm 314b, the electrolyte outlet channel section 316, the hydrogen gas inlet channel section 318a, and the hydrogen gas outlet channel section 318b.

The carbon foam 306 may be positioned in a cavity 326 of the plate 304 between the berm 314b and the electrolyte outlet channel section 316 along the y-axis and between the hydrogen gas inlet channel section 318a and the hydrogen gas outlet channel section 318b along the x-axis. Specifically, the carbon foam 306 may be positioned in face-sharing contact with a side of the plate 304 forming a base of the cavity 326. In some examples, the carbon foam 306 may be formed as a continuous monolithic piece, while in other examples, the carbon foam 306 may be formed as two or more carbon foam sections. In an exemplary embodiment, the carbon foam 306 may be conductive, permeable, and porous, providing a distribution field for the electrolyte being gravity fed therethrough from the plurality of electrolyte inlet passages 314a. In some examples, a pore distribution of the carbon foam 306 may be between 10 and 100 PPI. In one example, the pore distribution may be 30 PPI. In additional or alternative examples, a permeability of the carbon foam 306 may be between 0.02 and 0.5 mm². As such, each of the pore distribution and the permeability, in addition to an overall size, of the carbon foam 306 may be selected to target a relatively small pressure drop and thereby induce convection of the electrolyte from the carbon foam 306 into the positive electrode 308. For example, the pressure drop may be targeted to between 2 to 3 mm of electrolyte head rise.

In some examples, the carbon foam 306 may be replaced with a flow field plate configured to transport the electrolyte into the positive electrode 308 via convection induced by a flow field configuration of the flow field plate. Specifically, the flow field plate may be fluidically coupled to each of the plurality of electrolyte inlet passages 314a and the electrolyte outlet channel section 316. In one example, the flow field plate may be integrally formed in the plate 304 of the electrode assembly 302, positioned beneath the positive electrode 308 with respect to the z-axis. In other examples, the flow field plate may be a separate, removable component.

In some examples, the flow field configuration may be an interdigitated flow field configuration, a partially interdigitated flow field configuration, or a serpentine flow field configuration. In some examples, each electrode assembly 302 may interface with a flow field configuration of like configuration (e.g., interdigitated, partially interdigitated, serpentine, etc.) as each other electrode assembly 302. In other examples, a number of different flow field configurations may be provided among the electrode assemblies 302 in the stack of electrode assemblies (e.g., dependent upon a location of a given electrode assembly 302 in the rebalancing cell 202 of FIGS. 2A and 2B). In this way, the electrolyte may be directed from the electrolyte inlet port (e.g., the electrolyte inlet port 206 of FIGS. 2A and 2B) to the flow field plates respectively interfacing with the positive electrodes 308 in the stack of electrode assemblies, the flow field plates being configured in interdigitated flow field configurations, partially interdigitated flow field configurations, serpentine flow field configurations, or a combination thereof.

In certain examples, another flow field plate (also referred to herein as a “hydrogen gas flow field plate”) may interface with the negative electrode 310 opposite from the positive electrode 308 with respect to the z-axis. However, in other examples, only the electrolyte flow field plate may be included (e.g., replacing the carbon foam 306) and no hydrogen gas flow field plate may be present. In still other examples, only the hydrogen gas flow field plate may be included (e.g., interfacing with the negative electrode 310) and no electrolyte flow field plate may be present.

The positive electrode 308 may be positioned in the cavity 326 in face-sharing contact with a side of the carbon foam 306 opposite from the plate 304 along the z-axis. In an exemplary embodiment, the positive electrode 308 may be a wicking conductive carbon felt, sponge, or mesh which may bring the electrolyte flowing through the carbon foam 306 into contact with the negative electrode 310 via capillary action. Accordingly, in some examples, the positive electrode 308 may be conductive and porous (though less porous than the carbon foam 306 in such examples). In one example, the electrolyte may be wicked into the positive electrode 308 when the porosity of the carbon foam 306 is within a predefined range (e.g., below an upper threshold porosity so as to retain enough solid material to promote wicking up and into the positive electrode 308 and above a lower threshold porosity so as to not impede electrolyte flow through the carbon foam 306). In an additional or alternative example, each of a sorptivity of the positive electrode 308 may decrease and a permeability of the positive electrode 308 may increase with an increasing porosity of the positive electrode 308 (e.g., at least until too little solid material of the positive electrode 308 remains to promote wicking of the electrolyte, such as when a critical porosity of the positive electrode 308 is reached). In some examples, surfaces of the positive electrode 308 may be sufficiently hydrophilic for desirable rebalancing cell operation (e.g., by facilitating thorough electrolyte wetting and thereby forming an ionically conductive medium). In such examples, an overall hydrophilicity of the positive electrode 308 may be increased by coating or treating the surfaces thereof. Further, though at least some of the H₂ gas may pass into the positive electrode 308 in addition to a portion of the electrolyte wicked into the positive electrode 308, the positive electrode 308 may be considered a separator between a bulk of the H₂ gas thereabove and a bulk of the electrolyte therebelow.

In some examples, each of the positive electrode 308 and the negative electrode 310 may be formed as a continuous monolithic piece (e.g., as opposed to discrete particles or a plurality of pieces), such that interphase mass-transport losses across boundary layer films may be reduced when bringing the electrolyte into contact with the H₂ gas at the catalytic surfaces of the negative electrode 310, thereby promoting ionic and proton movement. In contrast, a packed bed configuration including discretely packed catalyst particles may include mass-transport limiting boundary layer films surrounding each individual particle, thereby reducing a rate of mass-transport of the electrolyte from a bulk thereof to surfaces of the particles.

The negative electrode 310 may be positioned in the cavity 326 in face-sharing contact with a side of the positive electrode 308 opposite from the carbon foam 306 along the z-axis, such that a three-phase contact interface between the (wicked) electrolyte, the catalytic surfaces of the negative electrode 310, and the H₂ gas may be formed for proton (e.g., H⁺) and ionic movement (H₃O⁺) therethrough. In tandem, the positive electrode 308 may reduce an overall electronic resistance by providing a conductive path for electrons to move into the electrolyte front and reduce Fe³⁺ ions thereat.

In an exemplary embodiment, the negative electrode 310 may be a porous non-conductive material or a conductive carbon substrate with a metal catalyst coated thereon. In some examples, the porous non-conductive material may include polytetrafluoroethylene (PTFE), polypropylene, or the like. In some examples, the conductive carbon substrate may include carbon cloth or carbon paper. In some examples, the metal catalyst may include a precious metal catalyst. In some examples, the precious metal catalyst may include Pt. In additional or alternative examples, the precious metal catalyst may include Pd, Rh, Ru, Ir, Ta, or alloys thereof. In some examples, a relatively small amount (e.g., 0.2 to 0.5 wt %) of the precious metal catalyst supported on the conductive carbon substrate may be employed for cost considerations. In practice, however, the amount of the precious metal catalyst is not particularly limited and may be selected based on one or more of a desired rate of reaction for the rebalancing cell and an expected lifetime of the rebalancing cell. Furthermore, alloys included in the precious metal catalyst may be utilized to reduce cost and increase a corrosion stability of the precious metal catalyst. For example, 10% addition of Rh to Pt may reduce corrosion of Pt by Fe³⁺ by over 98%. In other examples, the metal catalyst may include a non-precious metal catalyst selected for stability in ferric solution and other such acidic environments (e.g., molybdenum sulfide). In one example, the negative electrode 310 may include carbon cloth coated with 1.0 mg/cm² Pt and may include a microporous layer bound with a polytetrafluoroethylene (PTFE) binder (e.g., for hydrophobicity). Indeed, inclusion of the PTFE binder may increase a durability of rebalancing cell performance over extended durations relative to electrode assemblies formed using other binders.

In other examples, an activity of the catalyst in the negative electrode 310 may be maintained by applying an ion-repelling potential, from an external voltage source, across the electrode assemblies. By applying the ion-repelling potential, formation of a diffusion double layer at the catalyst surface may be inhibited, which may otherwise reduce catalytic activity. Modifications to the rebalancing cell configuration may be implemented in to enable application of the ion-repelling potential to the electrode assemblies of the rebalancing cell. Such modifications are discussed in detail with respect to FIGS. 4A-C.

In some examples, such as when the precious metal catalyst includes Pt, soaking of the negative electrode 310 in electrolyte may eventually result in corrosion of the precious metal catalyst. In other examples, and as discussed in above with reference to FIGS. 2A and 2B, the rebalancing cell may be tilted or inclined with respect to a surface on which the rebalancing cell rests (e.g., the z-axis may be non-parallel with a direction of gravity) such that the precious metal catalyst may remain relatively dry as flow of the electrolyte is drawn through the carbon foam 306 toward the electrolyte outlet channel section 316 via gravity feeding. Thus, in some examples, the electrode assembly 302 may either be horizontal or inclined with respect to the surface on which the rebalancing cell rests at an angle of between 0° and 30°.

In an exemplary embodiment, the electrode assembly 302, including each of the carbon foam 306, the positive electrode 308, and the negative electrode 310, may be under compression along the z-axis, with the positive electrode 308 having a greater deflection than the carbon foam 306 and the negative electrode 310 under a given compressive pressure. Accordingly, a depth of the cavity 326 may be selected based on a thickness of the carbon foam 306, a thickness of the positive electrode 308, a desired compression of the positive electrode 308, and a thickness of the negative electrode 310. Specifically, the depth of the cavity 326 may be selected to be greater than a lower threshold depth of a sum of the thickness of the carbon foam 306 after substantially complete compression thereof and the thickness of the positive electrode 308 after substantially complete compression thereof (to avoid overstressing and crushing of the carbon foam 306, which may impede electrolyte flow) and less than an upper threshold depth of a sum of the thickness of the carbon foam 306 and the thickness of the positive electrode 308 (to avoid zero compression of the positive electrode 308 and possibly a gap, which may result in insufficient contact of the H₂ gas and the electrolyte).

For instance, in an example wherein the thickness of the carbon foam 306 is 6 mm, the thickness of the positive electrode 308 is 3.4 mm, the desired compression of the positive electrode 308 is 0.4 mm (so as to achieve a desired compressive pressure of 0.01 MPa), and the thickness of the negative electrode 310 is 0.2 mm, the depth of the cavity 326 may be 9.2 mm (=3.4 mm+6 mm+0.2 mm-0.4 mm). As another example, the thickness of the carbon foam 306 may be between 2 and 10 mm, the thickness of the positive electrode 308 may be between 1 and 10 mm, the desired compression of the positive electrode 308 may be between 0 and 2.34 mm (so as to achieve the desired compressive pressure of 0 to 0.09 MPa), and the thickness of the negative electrode 310 may be between 0.2 and 1 mm, such that the depth of the cavity 326 may be between 0.86 and 21 mm. In additional or alternative examples, the thickness of the positive electrode 308 may be 20% to 120% of the thickness of the carbon foam 306. In one example, the thickness of the positive electrode 308 may be 100% to 110% of the thickness of the carbon foam 306.

In one example, the depth of the cavity 326 may further depend upon a crush strength of the carbon foam 306 (e.g., the depth of the cavity 326 may be increased with decreasing crush strength). For instance, a foam crush factor of safety (FOS) may be 5.78 when the depth of the cavity 326 is 9.2 mm (e.g., when the desired compression of the positive electrode is 0.4 mm). The foam crush FOS may have a minimum value of 0.34 in some examples, where foam crush FOS values less than 1 may indicate that at least some crushing is expected. In some examples, the crush strength of the carbon foam 306 may be reduced by heat treatment of the carbon foam 306 during manufacturing thereof (from 0.08 MPa to 0.03 MPa, in one example). It will be appreciated that the electrode assembly 302 may be configured such that the depth of the cavity 326 is as low as possible (e.g., within the above constraints), as generally thinner electrode assemblies 302 may result in a reduced overall size of the rebalancing cell and a reduced electrical resistance across the electrode assembly 302 (e.g., as the electrolyte flow may be closer to the negative electrode 310).

In this way, the electrode assembly 302 may include a sequential stacking of the carbon foam 306 and an interfacing pair of the positive electrode 308 and the negative electrode 310 being in face-sharing contact with one another and being continuously electrically conductive. Specifically, a first interface may be formed between the positive electrode 308 and the carbon foam 306 and a second interface may be formed between the positive electrode 308 and the negative electrode 310, the second interface being opposite to the first interface across the positive electrode 308, and each of the carbon foam 306, the positive electrode 308, and the negative electrode 310 may be electrically conductive. Accordingly, the electrode assembly 302 may be internally shorted, such that electric current flowing through the electrode assembly 302 may not be channeled through an external load.

In an exemplary embodiment, and as discussed above, forced convection may induce flow of the H₂ gas into the electrode assembly 302 and across the negative electrode 310 (e.g., via a flow field plate interfacing with the negative electrode 310; not shown at FIG. 3). Thereat, the H₂ gas may react with the catalytic surface of the negative electrode 310 via equation (4a) (e.g., the reverse reaction of equation (1)):

½H₂→+e⁻ (anodic half reaction) (4a)

The proton (H⁺) and the electron (e) may be conducted across the negative electrode 310 and into the positive electrode 308. The electrolyte, directed through the electrode assembly 302 via the carbon foam 306, may be wicked into the positive electrode 308. At and near the second interface between the positive electrode 308 and the negative electrode 310, Fe²⁺ in the electrolyte may be reduced via equation (4b):

Fe²⁺+e⁻→Fe²⁺ (cathodic half reaction) (4b)

Summing equations (4a) and (4b), the electrolyte rebalancing reaction may be obtained as equation (4):

Fe³⁺+½H₂→Fe²⁺+H⁺ (electrolyte rebalancing) (4)

Since the electrode assembly 302 is internally shorted, a cell potential of the electrode assembly 302 may be driven to zero as:

0=(Eₚₒₛ−E_{neg})−(η_{act}+ηₙₜ+ηₒₕₘ) (7)

where Eₚₒₛ is a potential of the positive electrode 308, E_{neg} is a potential of the negative electrode 310, mₐ is an activation overpotential, ηₙₜ is a mass transport overpotential, and ηₒₕₘ is an ohmic overpotential. For the electrode assembly 302 as configured in FIG. 3, ηₘₜ and η_{act} may be assumed to be negligible. Further, ηₒₕₘ may depend on an overpotential η_{electrolyte} of the electrolyte and an overpotential wₑlₜ of the carbon felt forming the positive electrode 308 as:

ηₒₕₘ=η_{electrolyte}+η_{felt} (8)

Accordingly, performance of the electrode assembly 302 may be limited at least by an electrical resistivity σ_{electrolyte} of the electrolyte and an electrical resistivity σ_{felt} of the carbon felt. The electrical conductivity of the electrolyte and the electrical conductivity of the carbon felt may further depend on da resistance R_{electrolyte} of the electrolyte and a resistance R_{felt} of the carbon felt, respectively, which may be given as:

R_{electrolyte}=σ_{electrolyte}×t_{electrolyte}/A_{electrolyte} (9)

R_{felt}=σ_{felt}×t_{felt}/A_{felt} (10)

where t_{electrolyte} is a thickness of the electrolyte (e.g., a height of the electrolyte front), t_{felt} is a thickness of the carbon felt (e.g., the thickness of the positive electrode 308), A_{electrolyte} is an active area of the electrolyte (front), and A_{felt} is an active area of the carbon felt. Accordingly, the performance of the electrode assembly 302 may further be limited based on a front location of the electrolyte within the carbon felt and therefore the distribution of the electrolyte across the carbon foam 306 and an amount of the electrolyte wicked into the carbon felt forming the positive electrode 308.

After determining R_{electrolyte} and R_{felt}, an electric current I_{assembly} of the electrode assembly 302 may be determined as:

I_{assembly}=(Eₚₒₛ−E_{neg})/(R_{electrolyte}+R_{felt}) (11)

and a rate v_{rebalancing} of the electrolyte rebalancing reaction (e.g., the rate of reduction of Fe³⁺) may further be determined as:

v_{rebalancing}=I_{assembly}/(nFA_{rebalancing}) (12)

where n is a number of electrons flowing through the negative electrode 310, F is Faraday's constant, and A_{rebalancing} is an active area of the electrolyte rebalancing reaction (e.g., an area of an interface between the electrolyte front and the negative electrode 310). As an example, for an uncompressed carbon felt having t_{felt}=3 mm, v_{rebalancing} may have a maximum value of 113 mol/m² hr.

Referring now to FIG. 4A, it shows an isometric view 400 of a rebalancing cell 402 for a redox flow battery system, such as redox flow battery system 10 of FIG. 1. It will be appreciated that the rebalancing cell 402 represents another embodiment of one or more of the rebalancing reactors/cells 80 and 82 of FIG. 1. Furthermore, the rebalancing cell 402 may include components and an overall geometry similar to the rebalancing cell 202 of FIGS. 2A-2B. As such, the rebalancing cell 402 includes a stack of electrode assemblies, each of the electrode assemblies configured similarly to the electrode assembly 302 of FIG. 3, stacked between a top endplate 432 and a bottom endplate 436. The rebalancing cell 402 may drive an electrolyte rebalancing reaction between H₂ gas and positive or negative electrolyte from compartments of a redox flow battery. such as the redox flow battery cell 18 of FIG. 1.

The rebalancing cell 402 may be configured to receive electrolyte at electrolyte inlet ports 404. The electrolyte inlet ports 404 may be similar to electrolyte inlet ports 206 of FIGS. 2A-2B. Electrolyte may be pumped from a negative electrode compartment and a positive electrode compartment, e.g., the negative electrode compartment 20 and positive electrode compartment 22 of FIG. 1, to the inlet ports 404 of the rebalancing cell 402. Additionally or alternatively, electrolyte may be pumped from an electrolyte storage tank, as shown in FIG. 5 and described below. Electrolyte may pass through the rebalancing cell 402 and undergo reduction by hydrogen gas according to equation (4), after which the electrolyte may exit the rebalancing cell 402 through an electrolyte outlet port 410. The electrolyte outlet port 410 may be similar to the electrolyte outlet port 208 of FIGS. 2A-2B. Electrolyte leaving the rebalancing cell 402 may be pumped to the electrolyte storage tank before replenishing electrode compartments of the redox flow battery system. Hydrogen gas which reacts with the electrolyte within the rebalancing cell 402 may enter through a hydrogen inlet port 412. The hydrogen inlet port 412 may be similar to the hydrogen gas inlet port 210 of FIGS. 2A-2B. Any unreacted hydrogen gas may pass through the rebalancing cell 402 and exit through hydrogen gas outlet ports 406, which may be similar to the hydrogen gas outlet ports 212 of FIGS. 2A-2B. As discussed with reference to FIGS. 2A-2B, other embodiments of the rebalancing cell 402 may include more or less of the electrolyte inlet and outlet ports 404 and 410 and more or less of the hydrogen inlet and outlet ports 412 and 406. Additionally, the electrolyte inlet ports 404 and outlet ports 410, as well as the hydrogen inlet and outlet ports 412 and 406, may be positioned at different locations on the rebalancing cell 402 relative to those shown in FIGS. 4A-4B, as discussed above with reference to FIGS. 2A-2B.

The top endplate 432 may form a top outer surface of the rebalancing cell 402. The hydrogen gas and electrolyte may pass through a plurality of electrode assemblies 434 forming a body of the rebalancing cell 402, where each of the plurality of electrode assemblies 434 may be similarly configured to the electrode assembly 302 of FIG. 3. The plurality of electrode assemblies (i.e., electrode assembly stack) 434 may each include a negative electrode and a positive electrode in face-sharing contact with one another, in addition to other components described above in detail with reference to FIG. 3. The bottom endplate 436 may form a bottom (e.g., relative to the negative z-axis) outer surface of the rebalancing cell 402. The electrolyte outlet 410 and the hydrogen inlet 412 may be positioned so that the hydrogen gas and electrolyte may pass through the bottom endplate 436.

A conductive coupler 408 may extend from the bottom endplate 436 of the rebalancing cell 402 to conductively couple the electrode assembly to an external voltage source, as shown in FIG. 4B. In an exemplary embodiment, the conductive coupler 408 may be a conductive wire that protrudes from a face of the rebalancing cell 402 along which the electrolyte outlet 410 and the hydrogen inlet 412 are positioned. For example, the conductive coupler 408 may protrude from an outer face of the bottom endplate 436. The conductive wire may be formed of a robust, conductive, and ductile material. As an example, a material of the conductive wire may be titanium or carbon.

Turning now to FIG. 4B, the rebalancing cell 402 is shown in a cutaway view 430. Similar to the isometric view 400 of FIG. 4A, the gas outlet port 406 and the electrolyte inlet ports 404 are positioned at the top (relative to the positive z-axis) of the rebalancing cell 402, allowing fluid and gas to pass through, e.g., across an inner face of, the top endplate 432. The endplates may be coupled to outermost electrode assemblies (i.e., at either end of rebalancing cell 402 along the z-axis) of the plurality of electrode assemblies 434 and the plurality of electrode assemblies 434 may be coupled to each other in a manner that seals fluids and gases within the rebalancing cell 402. As a result, the fluids and gases may exit and enter the rebalancing cell 402 only through the appropriate inlets and outlets. The conductive coupler 408 may extend from one of the plurality of electrode assemblies 434 at the bottom of the rebalancing cell 402, coupled to the bottom endplate 436, and may protrude from the rebalancing cell 402 through the bottom endplate 436 via a compression fitting 440. The compression fitting 440 is described in detail below with respect to FIG. 4C.

Turning now to FIG. 4C, a region 438 indicated in FIG. 4B is shown in greater detail in FIG. 4C, illustrating an arrangement of a conductive rod 462 which may be disposed between a positive electrode of one electrode cell of the plurality of electrode assemblies 434 and a negative electrode of an adjacent and adjoining electrode cell. As such, a number of the conductive rod 462 included in the rebalancing cell 402 may correspond to a number of electrode assemblies of the plurality of electrode assemblies 434 and the conductive rods may be aligned vertically, e.g., parallel with the z-axis, along a height of the rebalancing cell 402 and along each stack of the plurality of electrode assemblies 434. The conductive rod 462 may be a graphite rod, in one example. A diameter of the conductive rod 462 may be selected to match an inner diameter of a bore 464 protruding along the z-axis from each bipolar plate 450 of the plurality of electrode assemblies 434. The bore 464 of each bipolar plate 450 may contact a face of an adjacent bipolar plate 450. A length (e.g., as defined along the z-axis) of the conductive rod 462 may be similar to or longer than a distance between adjacent bipolar plates 450.

The length of the conductive rod 462 may cause a positive electrode 452, formed of a flexible material such as a felt, of each of the plurality of electrode assemblies 434 to be compressed between an end of the conductive rod 462 and the bipolar plate 450. Compression of the positive electrode 452 increases contact between the positive electrode 452 and a negative electrode, such as the negative electrode 310 of FIG. 3, coupled to the bipolar plate 450. As such, the negative electrode may be electrically shorted to the positive electrode 452, creating an electrically conductive path through each of the plurality of electrode assemblies 434 of the rebalancing cell 402.

The inner diameter of the bore 464 may be larger than the diameter of the conductive rod 462. The inner diameter of the bore 464 may allow the conductive rod 462 to have an interference fit that maintains a position of the conductive rod 462 within the bore 464 but allows the conductive rod 462 to reposition, e.g., shift, during assembly of the rebalancing cell 402. The bore 464 may be configured as a sleeve that circumferentially surrounds the conductive rod 462 in along spaces between the bipolar plates 450. In one example, as shown in FIG. 4C, the bore 464 may be continuous with, e.g., integrated into, the bipolar plate 450. In other examples, however, the bore 464 may be separate piece that may be attached to the bipolar plate 450 by, for example, welding.

The conductive coupler 408 may electrically couple a first electrode cell 434a of the plurality of electrode assemblies 434 to an external voltage source. As the first electrode cell 434a is electrically coupled to an adjacent electrode cell, e.g., an electrode cell directly above the first electrode cell 434a along the z-axis, via the conductive rod 462, the conductive coupler 408 may be electrically coupled to each electrode cell of the plurality of electrode assemblies 434. In an exemplary embodiment, the conductive coupler 408 may be in contact with and coupled to the positive electrode 452 of the first electrode cell 434a. The conductive coupler 408 may extend through the compression fitting 440, which may be an opening in the bottom endplate 436 reinforced with a sleeve. The compression fitting 440 may allow the conductive coupler 408 to extend outside of the rebalancing cell 402 to the external voltage source while maintaining electrolyte and hydrogen gas sealed within the rebalancing cell.

Implementation of a conductive wire (e.g., a conductive coupler) to apply an ion-repelling voltage potential to a rebalancing cell is shown in FIG. 5. Therein, a schematic diagram of an electrolyte management system 500 is illustrated, showing electrical and fluid connectivity between a rebalancing cell 508 (which may be similarly configured to the rebalancing cell 402 of FIGS. 4A-C) and an electrolyte tank 504 (which may be similarly configured to the multi-chambered electrolyte storage tank 110 of FIG. 1). Fluid passages are represented as arrows. Electrolyte may flow from the electrolyte tank 504 to the rebalancing cell 508 through a conduit 502, as driven by a pump 518. As described above with reference to FIGS. 2A-2B, gravity may also assist in draining electrolyte from the rebalancing cell 508 and into the electrolyte tank 504. One terminal of an external voltage source 510 may be connected to the rebalancing cell 508 via a conductive wire 514, which may be similar to the conductive coupler 408 of FIGS. 4A-4C. The external voltage source 510 may be a battery, for example, such as a lithium ion battery or a nickel metal hydride battery. While a negative terminal is coupled to the conductive wire 514 in FIG. 5, in other examples, a positive terminal of the external voltage source 510 may instead be coupled to the conductive wire 514. A terminal of the external voltage source 510, e.g., a terminal that is not coupled to the conductive wire 514, may be connected to a counter electrode 506 disposed within the electrolyte tank 504, the counter electrode 506 electrically coupled to the external voltage source 510 via an electrical wire 516. Additionally or alternatively, the counter electrode 506 may be disposed in a separate compartment that is fluidically coupled to the conduit 502.

The counter electrode 506 may be a conductive material that is physically and chemically capable of withstanding prolonged exposure to electrolyte. For example, the counter electrode may be formed from titanium mesh, conductive carbon rod, or graphite felt. In one example, the counter electrode 506 may have a surface area corresponding to a target ratio relative to an overall surface area of negative electrodes of the rebalancing cell 508. For example, the surface area of the counter electrode 506 may be less than or equal to ⅕ of the overall surface area of the negative electrodes. Maintaining the surface area of the counter electrode 506 smaller than the overall surface area of the negative electrodes according to the target ratio may reduce a likelihood of catalyst poisoning at the negative electrodes resulting from interaction with electrolyte anions.

Further, the external voltage source 510 may be grounded via an electrical ground 512, which may, as an example, be a portion of a redox flow battery system coupled to the rebalancing cell 508. For example, a housing of the redox flow battery system may be used to ground the external voltage source 510. The external voltage source 510 may be used to deliver a constant potential in a range of +2 V to −2V to electrode cells or assemblies of the rebalancing cell 508. In one example, the constant potential may be a negative potential, such as between −50 mV and −800 mV, and may be applied continuously during operation of the rebalancing cell 508. In other instances, the external voltage source 510 may be used to selectively apply a potential to the rebalancing cell 508 during charging of the redox flow battery system.

By applying the ion-repelling voltage potential to the electrode cells of the rebalancing cell during operation of the rebalancing cell, ions may be repelled from catalyst surfaces at negative electrodes of the electrode assemblies. For example, when a negative potential is applied to the rebalancing cell via the conductive wire, a negative charge is imposed on the electrode assemblies which may repel anions at the negative electrodes and catalyst surfaces. Similarly, if a positive potential is applied, cations may be repelled from the negative electrodes and catalyst surfaces. As a result, formation of a double diffusion layer at the catalyst surfaces is inhibited.

In some examples, a magnitude of the applied potential may be varied according to estimated degradation of catalyst performance. For example, when a ferric iron reduction rate is determined to decrease, the magnitude of the applied potential may be increased accordingly to increase a repulsive force hindering adsorption of ions at the catalyst surfaces.

An example of a method 600 for operating a rebalancing cell of an electrolyte management system, the rebalancing cell including a stack of internally shorted electrode assemblies (e.g., where electric current flowing through the stack of internally shorted electrode assemblies is not channeled to an external load) is shown. Moreover, the rebalancing cell is operated with an ion-repelling voltage potential applied from an external voltage source via a system such as the electrolyte management system 500 depicted in FIG. 5. The rebalancing cell may be implemented in a redox flow battery system for managing excess H₂ gas and rebalancing charge imbalances in electrolytes of the redox flow battery system, such that the redox flow battery system may be operated at a low internal pressure (e.g., a maximum pressure of the electrolyte and H₂ gas within the redox flow battery system may be maintained low, such as below a relatively low threshold pressure). For example, the low internal pressure may be at or near ambient pressure. In an exemplary embodiment, the redox flow battery system may be the redox flow battery system 10 of FIG. 1 and the rebalancing cell may be the rebalancing cell 402 of FIGS. 4A-4C. At least some steps or portions of steps (e.g., involving application of the ion-repelling voltage potential and receiving the H₂ gas and the electrolyte for distribution at the rebalancing cell) may be carried out via a controller such as the controller 88 of FIG. 1, and may be stored as executable instructions at a non-transitory storage medium (e.g., memory) communicably coupled to the controller. The method 600 may be executed upon activation of the redox flow battery system. For example, electrolyte flow may be driven by one or more active pumps and the redox flow battery system may be operating in a charging, discharging, or idling mode.

At 602, the method includes applying an ion-repelling voltage potential to the rebalancing cell from the external voltage source. As described above, the external voltage source may be a lithium ion or nickel metal hydride battery and electrical coupling of the external voltage source to the rebalancing cell may be control by a switch, for example. When the switch is adjusted to a closed position, current may flow from the external voltage source to the rebalancing cell via a conductive wire extending between a terminal of the external voltage source and an electrode assembly of the stack of electrode assemblies of the rebalancing cell. In one example, the switch may be closed continuously during operation of the redox flow battery system, thereby maintaining a constant potential on the stack of electrode assemblies. Alternatively, the switch may be selectively closed during charging of the redox flow battery system.

At 604, the method includes receiving the H₂ gas and the electrolyte at the rebalancing cell via respective inlet ports thereof. Specifically, the electrolyte may be received at the rebalancing cell via a first inlet port and the H₂ gas may be received at the rebalancing cell via a second inlet port. In one example, the first inlet port may be positioned above the second inlet port with respect to a direction of gravity. The H₂ gas may be delivered from a head space of an electrolyte storage tank and the electrolyte may be delivered from an electrode compartment of the redox flow battery system. The electrolyte may be received continuously at the rebalancing cell during operation of the redox flow battery system while the H₂ gas may be received at the rebalancing cell when a pressure in the electrolyte storage tank reaches a threshold pressure due to accumulation of the H₂ gas. In other examples, however, the electrolyte may be selectively flowed to the rebalancing cell, e.g., by opening/closing a valve and/or operating a hydrogen pump, when the H₂ gas is detected to reach the threshold pressure and selectively delivered to the rebalancing cell along with the electrolyte from the electrode compartment.

The method includes distributing the H₂ gas and the electrolyte throughout the stack of internally shorted electrode assemblies at 606. Specifically, the electrolyte may be distributed via an inlet manifold including a plurality of first inlet channels respectively coupled to the electrode assemblies of the stack of internally shorted electrode assemblies and the H₂ gas may be distributed via a second inlet channel formed by the stack of internally shorted electrode assemblies and fluidically coupled to each electrode assembly of the stack of internally shorted electrode assemblies. In some examples, after distribution via the inlet manifold, the electrolyte may be flowed through first flow field plates respectively interfacing with positive electrodes of the stack of internally shorted electrode assemblies. In other examples, after distribution via the inlet manifold, the electrolyte may flow through activated carbon foams interfacing with the positive electrodes. In some examples, after distribution via the second inlet channel, the H₂ gas may be distributed through second flow field plates interfacing with negative electrodes of the stack of internally shorted electrode assemblies.

At 608, the method includes inducing flows (e.g., crosswise, parallel, or opposing flows) of the H₂ gas and the electrolyte to facilitate an electrolyte rebalancing reaction at the negative and positive electrodes of the stack of internally shorted electrode assemblies. The negative and positive electrodes may be arranged amongst the stack of internally shorted electrode assemblies in interfacing pairs of negative and positive electrodes. As discussed above, each positive electrode of the interfacing pairs of negative and positive electrodes may further interface with a respective activated carbon foam or a respective first flow field plate. In one example, the negative electrode may be a conductive carbon substrate having a Pt catalyst coated thereon and the positive electrode may be a carbon felt.

In some examples, inducing flows of the H₂ gas and the electrolyte may include: (i) at 610, inducing flow of the H₂ gas across the negative electrodes of the stack of internally shorted electrode assemblies via convection (e.g., forced convection via the second flow field plates interfacing with the negative electrodes of the stack of internally shorted electrode assemblies); and (ii) at 612, inducing flow of the electrolyte across the positive electrodes of the stack of internally shorted electrode assemblies via one or more of gravity feeding (e.g., by tilting the rebalancing cell relative to a direction of gravity), capillary action (e.g., wicking up the electrolyte into the positive electrodes of the stack of internally shorted electrode assemblies), and convection (e.g., forced convection via the first flow field plates interfacing with the positive electrodes of the stack of internally shorted electrode assemblies). In one example, the flow of H₂ gas may be induced across the negative electrodes by convection and the flow of the electrolyte may be induced across the positive electrodes at the low internal pressure by each of gravity feeding and capillary action. Upon flowing the H₂ gas and the electrolyte across the negative and positive electrodes of the stack of internally shorted electrode assemblies, the electrolyte rebalancing reaction may occur, which may include, at 614, reacting the H₂ gas with positively charged ions in the electrolyte to reduce the positively charged ions (see equation (4)).

At 616, the method includes expelling the electrolyte (having the reduced positively charged ions, e.g., a lower concentration of Fe³⁺ than when initially received at the first inlet port at 604) and any unreacted H₂ gas from the rebalancing cell via outlet ports thereof. Specifically, at 618, the electrolyte may be expelled from the rebalancing cell via a first outlet port (e.g., an electrolyte outlet port) and, at 620, the unreacted H₂ gas may be expelled from the rebalancing cell via a second outlet port (e.g., a gas relief port). The method ends.

Benefits of applying an ion-repelling voltage to the rebalancing cell may be experimentally demonstrated by testing a subscale redox flow battery design. FIG. 7 shows a graph 700 plotting normalized performance of a negative electrode of the rebalancing cell, depicted on a percent scale, relative to a reduction rate of ferric (Fe³⁺) ions in mol/m². Data set 702, plotted as solid circles, represents rebalancing cell operation with an applied potential of between +2V and −2V relative to a counter electrode from an external voltage source. Data set 704, plotted as diamonds, represents operation of the rebalancing cell without the applied potential. The results illustrated in graph 700 indicate an increased durability and prolonged efficiency of the negative electrode (e.g., of a catalyst of the negative electrodes) when the potential is applied compared to when the potential is not applied.

In this way, the plurality of electrode assemblies of the rebalancing cell may be conductively coupled to an external voltage source. The external voltage source may be used to apply an electric potential across each negative electrode of the plurality electrode assemblies, thus repelling ions from a catalyst at surfaces of the negative electrodes. By repelling the ions, formation of diffusion double layers at the catalyst may be inhibited, which may otherwise decrease an activity of the catalyst and lead to degradation of the rebalancing cell performance.

FIGS. 2A-4C show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 2A-4C are drawn approximately to scale, although other dimensions or relative dimensions may be used.

The disclosure also provides support for a redox flow battery system, comprising: one or more redox flow battery cells, and a rebalancing cell receiving electrolyte from the one or more redox flow battery cells, the rebalancing cell configured to catalyze hydrogen reduction of metal cations, and a conductive coupler connecting the rebalancing cell to an external voltage source to enable application of an ion-repelling potential to a stack of electrode assemblies of the rebalancing cell during operation of the redox flow battery system. In a first example of the system, the conductive coupler is a conductive wire electrically coupled to the external voltage source and to one electrode assembly of the stack of electrode assemblies, and wherein the external voltage source is one of a lithium ion battery or a nickel metal hydride battery. In a second example of the system, optionally including the first example, each electrode assembly of the stack of electrode assemblies includes a positive electrode in face-sharing contact with a negative electrode. In a third example of the system, optionally including one or both of the first and second examples, each electrode assembly is electrically shorted by the face-sharing contact between the positive electrode and the negative electrode. In a fourth example of the system, optionally including one or more or each of the first through third examples, the negative electrode of each electrode assembly includes a catalyst at surfaces of the negative electrode and wherein the catalyst catalyzes the hydrogen reduction of the metal cations. In a fifth example of the system, optionally including one or more or each of the first through fourth examples, the ion-repelling potential is a negative potential between −50 mV and −800 mV, and wherein the ion-repelling potential repels anions from catalyst surfaces of the rebalancing cell. In a sixth example of the system, optionally including one or more or each of the first through fifth examples, the ion-repelling potential is a potential between −2 mV and 2 mV. In a seventh example of the system, optionally including one or more or each of the first through sixth examples, the system further comprises: a counter electrode electrically coupled to the external voltage source and positioned in an electrolyte storage tank of the redox flow battery system.

The disclosure also provides support for a method for a redox flow battery system, comprising: applying an ion-repelling potential to a rebalancing cell of the redox flow battery system from an external voltage source to inhibit adsorption of ions at catalyst surfaces of the rebalancing cell, and receiving hydrogen gas and electrolyte at the rebalancing cell, the hydrogen gas delivered from an electrolyte storage tank and the electrolyte delivered from an electrode compartment of the redox flow battery system, to facilitate a rebalancing reaction at an electrode assembly stack of the rebalancing reaction, the rebalancing reaction including reducing metal cations in the electrolyte via the hydrogen gas. In a first example of the method, applying the ion-repelling potential to the rebalancing cell includes coupling a conductive wire to a first electrode assembly of the rebalancing cell, the conductive wire extending between the first electrode assembly and the external voltage source. In a second example of the method, optionally including the first example, coupling the conductive wire to the first electrode assembly includes attaching the conductive wire to a positive electrode of the first electrode assembly. In a third example of the method, optionally including one or both of the first and second examples, applying the ion-repelling potential to the rebalancing cell includes conducting the ion-repelling potential from the first electrode assembly to a plurality of electrode assemblies of the electrode assembly stack of the rebalancing cell, the electrode assembly stack including the first electrode assembly, and wherein the first electrode assembly and the plurality of electrode assemblies are electrically coupled. In a fourth example of the method, optionally including one or more or each of the first through third examples, the hydrogen gas is received from a head space of the electrolyte storage tank and wherein the hydrogen gas is generated by side reactions occurring at a plating electrode of a redox flow battery cell of the redox flow battery system. In a fifth example of the method, optionally including one or more or each of the first through fourth examples, the electrolyte is received from one or more of a negative electrolyte compartment and a positive electrolyte compartment of a redox flow battery cell of the redox flow battery system. In a sixth example of the method, optionally including one or more or each of the first through fifth examples, applying the ion-repelling potential to the rebalancing cell includes applying a potential between +2 V to −2 V. In a seventh example of the method, optionally including one or more or each of the first through sixth examples, the rebalancing reaction is catalyzed at negative electrodes of the electrode assembly stack. In an eighth example of the method, optionally including one or more or each of the first through seventh examples, the rebalancing reaction at is catalyzed at internally shorted electrode assemblies of the electrode assembly stack, and wherein the internally shorted electrode assemblies are internally shorted by arranging a positive electrode and a negative electrode of each of the internally shorted electrode assemblies in direct contact with one another.

The disclosure also provides support for an electrolyte management system for a redox flow battery system, comprising, a redox flow battery cell, an electrolyte storage tank fluidically coupled to the redox flow battery cell, and a rebalancing cell configured to receive electrolyte from the redox flow battery cell and hydrogen gas from the electrolyte storage tank, the rebalancing cell electrically coupled to an external voltage source via a conductive coupler to receive an ion-repelling potential from the external voltage source, the ion-repelling potential mitigating formation of a double diffusion layer at catalyst surfaces of the rebalancing cell. In a first example of the system, the conductive coupler is connected to an electrode assembly arranged proximate to an endplate of the rebalancing cell, and wherein the conductive coupled protrudes out of the rebalancing cell through a compression fitting extending through the endplate. In a second example of the system, optionally including the first example, the rebalancing cell includes internally shorted electrode assemblies with a positive electrode in direct contact with a negative electrode of the rebalancing cell, and wherein the positive electrode is in direct contact with the negative electrode by pressing the positive electrode against the negative electrode with a conductive rod coupled to a bipolar plate of each of the internally shorted electrode assemblies.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A redox flow battery system, comprising:
one or more redox flow battery cells;
a rebalancing cell receiving electrolyte from the one or more redox flow battery cells, the rebalancing cell configured to catalyze hydrogen reduction of metal cations, and
a conductive coupler connecting the rebalancing cell to an external voltage source to enable application of an ion-repelling potential to a stack of electrode assemblies of the rebalancing cell during operation of the redox flow battery system.

2. The redox flow battery system of claim 1, wherein the conductive coupler is a conductive wire electrically coupled to the external voltage source and to one electrode assembly of the stack of electrode assemblies, and wherein the external voltage source is one of a lithium ion battery or a nickel metal hydride battery.

3. The redox flow battery system of claim 2, wherein each electrode assembly of the stack of electrode assemblies includes a positive electrode in face-sharing contact with a negative electrode.

4. The redox flow battery system of claim 3, wherein each electrode assembly is electrically shorted by the face-sharing contact between the positive electrode and the negative electrode.

5. The redox flow battery system of claim 3, wherein the negative electrode of each electrode assembly includes a catalyst at surfaces of the negative electrode and wherein the catalyst catalyzes the hydrogen reduction of the metal cations.

6. The redox flow battery system of claim 1, wherein the ion-repelling potential is a negative potential between −50 mV and −800 mV, and wherein the ion-repelling potential repels anions from catalyst surfaces of the rebalancing cell.

7. The redox flow battery system of claim 1, wherein the ion-repelling potential is a potential between −2 mV and 2 mV.

8. The redox flow battery system of claim 1, further comprising a counter electrode electrically coupled to the external voltage source and positioned in an electrolyte storage tank of the redox flow battery system.

9. A method for a redox flow battery system, comprising:
applying an ion-repelling potential to a rebalancing cell of the redox flow battery system from an external voltage source to inhibit adsorption of ions at catalyst surfaces of the rebalancing cell; and
receiving hydrogen gas and electrolyte at the rebalancing cell, the hydrogen gas delivered from an electrolyte storage tank and the electrolyte delivered from an electrode compartment of the redox flow battery system, to facilitate a rebalancing reaction at an electrode assembly stack of the rebalancing reaction, the rebalancing reaction including reducing metal cations in the electrolyte via the hydrogen gas.

10. The method of claim 9, wherein applying the ion-repelling potential to the rebalancing cell includes coupling a conductive wire to a first electrode assembly of the rebalancing cell, the conductive wire extending between the first electrode assembly and the external voltage source.

11. The method of claim 10, wherein coupling the conductive wire to the first electrode assembly includes attaching the conductive wire to a positive electrode of the first electrode assembly.

12. The method of claim 10, wherein applying the ion-repelling potential to the rebalancing cell includes conducting the ion-repelling potential from the first electrode assembly to a plurality of electrode assemblies of the electrode assembly stack of the rebalancing cell, the electrode assembly stack including the first electrode assembly, and wherein the first electrode assembly and the plurality of electrode assemblies are electrically coupled.

13. The method of claim 9, wherein the hydrogen gas is received from a head space of the electrolyte storage tank and wherein the hydrogen gas is generated by side reactions occurring at a plating electrode of a redox flow battery cell of the redox flow battery system.

14. The method of claim 9, wherein the electrolyte is received from one or more of a negative electrode compartment and a positive electrode compartment of a redox flow battery cell of the redox flow battery system.

15. The method of claim 9, wherein applying the ion-repelling potential to the rebalancing cell includes applying a potential between +2 V to −2 V.

16. The method of claim 9, wherein the rebalancing reaction is catalyzed at negative electrodes of the electrode assembly stack.

17. The method of claim 9, wherein the rebalancing reaction at is catalyzed at internally shorted electrode assemblies of the electrode assembly stack, and wherein the internally shorted electrode assemblies are internally shorted by arranging a positive electrode and a negative electrode of each of the internally shorted electrode assemblies in direct contact with one another.

18. An electrolyte management system for a redox flow battery system, comprising;
a redox flow battery cell;
an electrolyte storage tank fluidically coupled to the redox flow battery cell; and
a rebalancing cell configured to receive electrolyte from the redox flow battery cell and hydrogen gas from the electrolyte storage tank, the rebalancing cell electrically coupled to an external voltage source via a conductive coupler to receive an ion-repelling potential from the external voltage source, the ion-repelling potential mitigating formation of a double diffusion layer at catalyst surfaces of the rebalancing cell.

19. The electrolyte management system of claim 18, wherein the conductive coupler is connected to an electrode assembly arranged proximate to an endplate of the rebalancing cell, and wherein the conductive coupler protrudes out of the rebalancing cell through a compression fitting extending through the endplate.

20. The electrolyte management system of claim 19, wherein the rebalancing cell includes internally shorted electrode assemblies with a positive electrode in direct contact with a negative electrode of the rebalancing cell, and wherein the positive electrode is in direct contact with the negative electrode by pressing the positive electrode against the negative electrode with a conductive rod coupled to a bipolar plate of each of the internally shorted electrode assemblies.
